(19) United States
(12) Patent Application Publication
(10) Pub. No.: US 2018/0374270 A1
(43) Pub. Date: Dec. 27, 2018

(54) INFORMATION PROCESSING DEVICE, INFORMATION PROCESSING METHOD, PROGRAM, AND SERVER

(71) Applicant: SONY CORPORATION, TOKYO (JP)

(72) Inventors: SHINOBU KURIYA, KANAGAWA (JP); SOTA MATSUZAWA, TOKYO (JP)

(73) Assignee: SONY CORPORATION, TOKYO (JP)

(21) Appl. No.: 16/062,899

(22) PCT Filed: Sep. 29, 2016
(86) PCT No.: PCT/JP2016/078813

§ 371 Date: Jun. 15, 2018

(30) Foreign Application Priority Data
Jan. 7, 2016 (JP) 2016-001672

(51) Int. Cl. G06T 19/00; G06F 3/14; G06F 3/01; H04W 4/02; G02B 27/01; G06F 17/30

(52) U.S. Cl. CPC G06T 19/006; G06F 3/14; G06F 17/30525; H04W 4/02; G02B 27/017; G06F 3/011

(57) ABSTRACT

To change the display of the information associated with the moving real object depending on the position of the real object. Provided is an information processing device including: a display control unit configured to control display of tag information managed in association with position information of a real object. The display control unit controls the display of the tag information in such a manner that the display of the tag information is changed depending on a change in the position information of the real object. Also provided is a server including: an object management unit configured to manage an update of position information of a real object on a basis of the collected position information of the real object; and a control unit configured to cause the position information of the real object and tag information managed in association with the position information of the real object to be transmitted to an information processing device.

### TECHNICAL FIELD

The present disclosure relates to an information processing device, an information processing method, a program, and a server.

### BACKGROUND ART

Information processing terminals capable of acquiring position information are recently widespread. In addition, various services using position information are developed. In one example, Patent Literature 1 discloses an information processing method of displaying information entered by the user on a map image in association with position information.

### CITATION LIST

### Patent Literature

Patent Literature 1: JP 2015-003046A

### DISCLOSURE OF INVENTION

### Technical Problem

The services as describe above, however, do not contemplate a real object whose position varies as a target to be associated with information. Thus, the services as described above are difficult for the user to check the information associated with a moving real object.

In view of the above, the present disclosure provides a novel and improved information processing device, information processing method, program, and server, capable of changing display of information associated with a moving real object depending on the position of the real object.

### Solution to Problem

According to the present disclosure, there is provided an information processing device including: a display control unit configured to control display of tag information managed in association with position information of a real object. The display control unit controls the display of the tag information in such a manner that the display of the tag information is changed depending on a change in the position information of the real object.

In addition, according to the present disclosure, there is provided a server including: an object management unit configured to manage an update of position information of a real object on a basis of the collected position information of the real object; and a control unit configured to cause the position information of the real object and tag information managed in association with the position information of the real object to be transmitted to an information processing device.

### Advantageous Effects of Invention

As described above, according to the present disclosure, it is possible to change the display of the information associated with the moving real object depending on the position of the real object. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a system configuration example regarding display control of tag information according to the present disclosure.

FIG. 2 is a diagram illustrated to describe display control of tag information according to the present disclosure.

FIG. 3 is a diagram illustrated to describe display control of tag information according to the present disclosure.

FIG. 4 is a functional block diagram of an information processing device according to the present disclosure.

FIG. 5 is a functional block diagram of a server according to the present disclosure.

FIG. 6 is a functional block diagram of a real object according to the present disclosure.

FIG. 7 is an example of a table of an object management unit according to a first embodiment.

FIG. 8 is an example of a table of a user management unit according to the present embodiment.

FIG. 9 is a diagram illustrated to describe display control of tag information regarding a battle game according to the present embodiment.

FIG. 10 is a diagram illustrated to describe simplified display of tag information according to the present embodiment.

FIG. 11 is a diagram illustrated to describe the specifying of a real object according to the present embodiment.

FIG. 12 is a diagram illustrated to describe tag display as an avatar according to the present embodiment.

FIG. 13 is a diagram illustrated to describe recognition of a battle command according to the present embodiment.

FIG. 14 is a sequence diagram regarding registration control according to the present embodiment.

FIG. 15 is a sequence diagram regarding position information update control according to the present embodiment.

FIG. 16 is a sequence diagram regarding acquisition control of an information list related to a real object according to the present embodiment.

FIG. 17 is a sequence diagram regarding battle control according to the present embodiment.

FIG. 18 is a sequence diagram regarding control of tag setting according to the present embodiment.

FIG. 19 is a diagram illustrated to describe a bomb game according to a second embodiment.

FIG. 20 is a diagram illustrated to describe a collection game according to a third embodiment.

FIG. 21 is a diagram illustrated to describe an evaluation function according to a fourth embodiment.

FIG. 22 is a diagram illustrated to describe language guidance according to a fifth embodiment.

FIG. 23 is a diagram illustrating a hardware configuration example of an information processing device and a server according to the present disclosure.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Moreover, the description will be given in the following order.

1. Control of tag display according to present disclosure

### 1.1. What is Augmented Reality?

1.2. System configuration example according to present disclosure
1.3. Overview regarding control of tag display
1.4. Information processing device 10 according to present disclosure
1.5. Server 20 according to present disclosure
1.6. Real object 30 according to present disclosure
1.7. Modification of functional configuration according to present disclosure
2. First embodiment (battle game intended to contest real object 30)
2.1. Overview of battle game according to first embodiment
2.2. Example of information managed by server 20
2.3. Display control of information regarding battle game
2.4. Simplified display information
2.5. Specifying real object 30 to be attacked
2.6. Display control of specifying the real object 30
2.7. Control of input regarding battle
2.8. Control flow according to present embodiment
2.9. Summary of first embodiment
3. Second embodiment (bomb game using real object 30)
3.1. Overview of bomb game according to second embodiment
3.2. Details of bomb game according to second embodiment
3.3. Summary of second embodiment
4. Third embodiment (collection game intended to collect real objects 30)
4.1. Overview of collection game according to third embodiment
4.2. Details of collection game according to second embodiment
4.3. Summary of third embodiment
5. Fourth embodiment (evaluation function using real object 30)
5.1. Overview of evaluation function according to fourth embodiment
5.2. Details of evaluation function according to fourth embodiment
5.3. Summary of fourth embodiment
6. Fifth embodiment (language guidance using real object 30)
6.1. Overview of language guidance according to fifth embodiment
6.2. Details of language guidance according to fifth embodiment
6.3. Summary of fifth embodiment
7. Hardware configuration example
7.1. Common component
7.2. Component specific to the information processing device 10

### 8. Conclusion

### 1. Control of Tag Display According to Present Disclosure

### <<1.1. What is Augmented Reality?>>

Technology called augmented reality (AR) that superimposes additional information on the real space and presents it to the user has recently attracted attention. In AR technology, information presented to users is visualized in various forms of virtual objects such as text, icons, animation. The virtual object is arranged depending on the position of a real object associated with the virtual object. The virtual object is typically displayed on a display of an information processing terminal.

An application in which AR technology is applied, in one example, make it possible to associate additional information such as navigation information or advertisements with a real object such as buildings or roads existing in real space and to present it to the user. The application as described above, however, contemplates a real object whose position does not vary as a target to be associated with additional information. An information processing device and a server according to the present disclosure are conceived in view of the above points and are capable of displaying additional information associated with a moving real object. In addition, the information processing device and the server according to the present disclosure are capable of associating new additional information with a moving real object. In the following, characteristics of the information processing device and the server according to the present disclosure and the effects derived from the characteristics will be described.

### <<1.2. System Configuration Example According to Present Disclosure>>

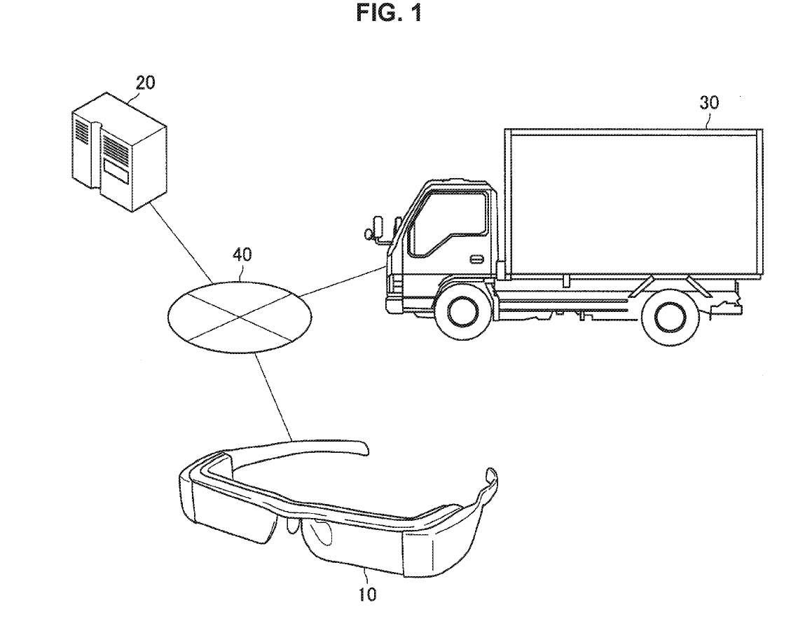

A configuration example of an information system according to the present disclosure is now described with reference to FIG. 1. Referring to FIG. 1, the information system according to the present disclosure includes an information processing device 10, a server 20, and a real object 30. In addition, these components are capable of communicating with each other via a network 40. Here, the information processing device 10 is a device for presenting additional information (hereinafter also referred to as tag information) associated with the real object 30 to the user. In addition, the information processing device 10 is capable of setting new tag information to be associated with the real object 30 and transmitting it to the server 20. The server 20 has a function of acquiring position information from the real object 30 and updating the position information of the real object 30 held by the server 20. In addition, the server 20 executes various processing corresponding to the mode of an application to be provided while communicating with the information processing device 10. The real object 30 is conceived to be a moving real object or a real object that is movable by a third party. The real object 30 may also have a function of transmitting the position information to the server 20 or a function of providing the information processing device 10 with identification information of the real object 30.

In the following description of tag display control according to the present disclosure, a head-mounted display (HMD) is described as an example of the information processing device 10, and a vehicle is described as an example of the real object 30, but the information processing device 10 and the real object 30 are not limited to those of such example. The information processing device 10 according to the present disclosure may be, in one example, a mobile phone, a smartphone, a tablet, or a personal computer (PC). In addition, the information processing device 10 may be an eyeglass or contact lens type wearable device, an information processing device used by being installed in ordinary eyeglasses, or the like. In addition, the real object 30 according to the present disclosure may be an object such as a ship, an animal, a chair, or the like equipped with a GPS sensor.

### <<1.3. Overview Regarding Control of Tag Display>>

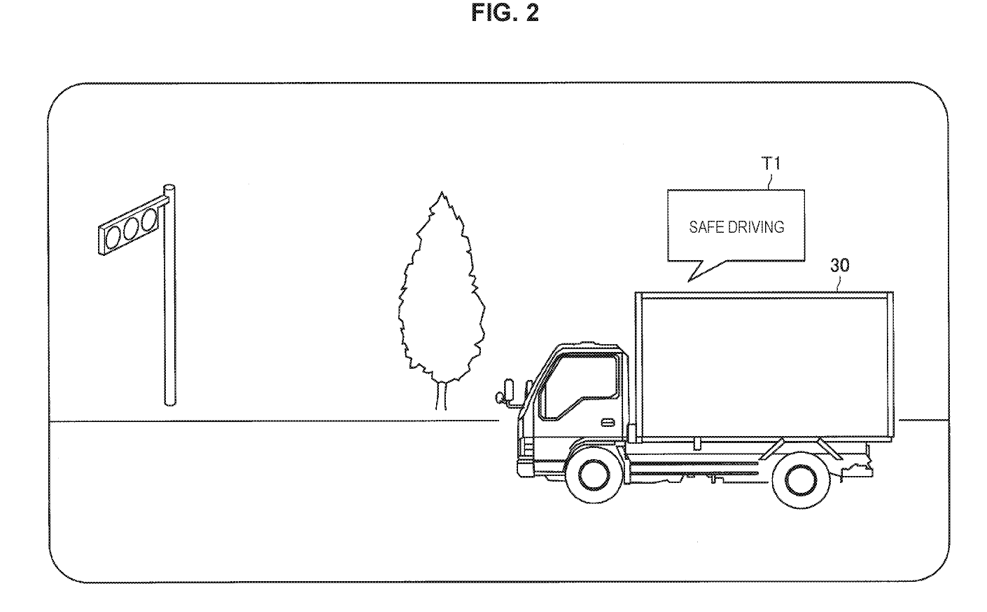

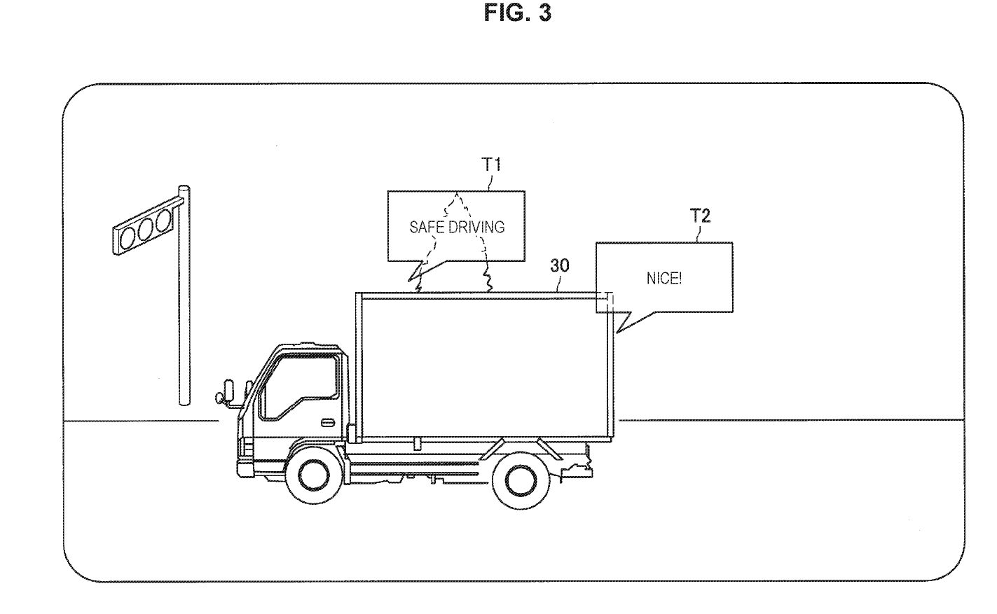

Then, an overview of tag display control according to the present disclosure is described with reference to FIGS. 2 and 3. The information processing device and the server according to the present disclosure are capable of causing additional information associated with a moving real object to be displayed. In addition, the information processing device and the server according to the present disclosure are capable of associating new additional information with the moving real object. FIG. 2 is an image diagram of visual information obtained by the user through the information processing device 10 such as HMD. FIG. 2 illustrates visual information of the real space including the real object 30 and a tag display T1 whose display is controlled by the information processing device 10. In this example, the tag display T1 is indicated as text information, “during safe driving”.

In this example, the real object 30 transmits its own position information acquired by using a global positioning system (GPS), Wi-Fi, or the like to the server 20. The server 20 transmits the acquired position information of the real object 30 and tag information associated with the real object 30 to the information processing device 10. The information processing device 10 controls the display position of the tag display T1 on the basis of the acquired position information of the real object 30 and the tag information associated with the real object 30.

Further, the server 20, when acquiring the new position information of the real object 30, updates the position information of the real object 30 held in the server 20 and transmits the updated position information to the information processing device 10. The information processing device 10 controls the display position of the tag display T1 on the basis of the acquired new position information of the real object 30. Moreover, the server 20, when updating the position information of the real object 30, may again acquire the tag information associated with the real object 30 and transmit it to the information processing device 10.

The processing regarding the addition of tag information to the real object 30 is now described. The information processing device 10 transmits information entered by the user to the server 20 together with identification information of the target real object 30. The server 20 links the information entered by the user with the target real object 30 on the basis of the acquired contents, and sets it as new tag information. Upon completion of the setting, the server 20 transmits the new tag information and the position information of the real object 30 to the information processing device 10. In addition, the information processing device 10 controls the display position of a new tag display on the basis of the acquired tag information and position information of the real object 30. Moreover, the information processing device 10 is also capable of generating a tag display and controlling the display position without transmitting the information entered by the user to the server 20.

The overview of the tag display control according to the present disclosure is described above. Here, when referring to FIG. 3, it can be found that the position of the real object 30 and the display position of the tag display T1 are changed, as compared with the state of FIG. 2. Furthermore, text information “nice!” is added as a new tag display T2. In other words, FIG. 3 illustrates that the display position of the tag display T1 follows the movement of the real object 30. Moreover, the tag display T2 indicates an example of tag display generated from the tag information newly associated with the real object 30 by the user.

As described above, the information processing device 10 according to the present disclosure is capable of controlling the display position of the tag display on the basis of the position information of the moving real object 30 and the tag information associated with the real object 30. In addition, the information processing device 10 is capable of adding new tag information to the moving real object 30.

### <<1.4. Information Processing Device 10 According to Present Disclosure>>

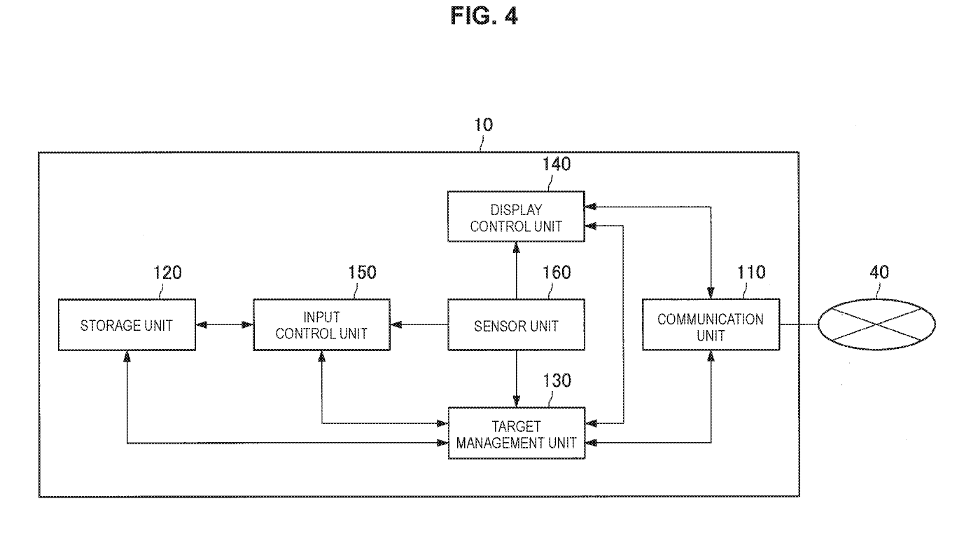

The information processing device according to the present disclosure is now described in detail. As described above, the information processing device 10 according to the present disclosure has a function of controlling the display of tag information associated with the real object 30. In addition, the information processing device 10 has a function of adding new tag information to the real object 30. A functional configuration example of the information processing device 10 according to the present disclosure is now described with reference to FIG. 4.

### (Communication Unit 110)

A communication unit 110 has a function of performing information communication with the server 20 or the real object 30. Specifically, the communication unit 110 receives position information of the real object 30, tag information associated with the real object 30, or the like from the server 20. In addition, the communication unit 110 transmits tag information that is set by an input control unit 150 to be described later or position information of the information processing device 10 to the server 20. In addition, the communication unit 110 may have a function of acquiring identification information, position information, or the like from the real object 30 using short-range wireless communication.

### (Storage Unit 120)

A storage unit 120 has a function of storing programs or various kinds of information to be used by the components in the information processing device 10. Specifically, the storage unit 120 stores identification information of the information processing device 10, setting information related to a filtering function of tag information to be described later, tag information set in the past, or the like.

### (Target Management Unit 130)

A target management unit 130 manages the position information of the real object 30 that is acquired from the server 20 and manages the tag information associated with the real object 30. The target management unit 130 has a function of linking the tag information set by the input control unit 150 with the target real object 30.

### (Display Control Unit 140)

A display control unit 140 controls display of the tag information managed in association with the position information of the real object in such a manner that the display is changed depending on a change in the position information of the real object. Specifically, the display control unit 140 controls the display of the tag information associated with the real object 30, on the basis of the information managed by the target management unit 130 and the position information and direction information of the information processing device 10 that are acquired from a sensor unit 160 to be described later. In addition, the display control unit 140 has a function of specifying the position of the real object 30 in detail on the basis of the information from the sensor unit 160. The display control unit 140 is capable of specifying the detailed position of the real object 30 or recognizing the target real object 30 by using, in one example, a technique such as image recognition or simultaneous localization and mapping (SLAM). In addition, the display control unit 140 has a function of filtering the tag information to be displayed depending on the type of the tag information. Moreover, the display of the tag information controlled by the display control unit 140 is not limited to the display on a display device. In one example, the display control unit 140 may control tag display using projection mapping by, in one example, controlling a projection device such as projectors.

### (Input Control Unit 150)

The input control unit 150 has a function of setting contents of the tag information. Here, the real object 30 to be set as the tag information is specified on the basis of the information acquired by the sensor unit 160. The information to be set as contents of the tag information may be information that is input through the touch panel or various buttons or may be input by voice or gesture. The input control unit 150 is capable of recognizing the input contents and setting it as the tag information on the basis of the user's voice or gesture information acquired by the sensor unit 160. In addition, the input control unit 150 has a function of estimating tag information to be set on the basis of a tendency of tag information set in the past or the information acquired from the sensor unit 160. The input control unit 150 is capable of estimating the tag information to be set from, in one example, information or the like related to the user's heart rate, blood pressure, breathing, or perspiration that is acquired from the sensor unit 160.

### (Sensor Unit 160)

The sensor unit 160 includes various types of sensors and has a function of collecting information corresponding to the type of sensor. The sensor unit 160 may include, in one example, a GPS sensor, an accelerometer, a gyro sensor, a geomagnetic sensor, an infrared sensor, a barometer, an optical sensor, a temperature sensor, a microphone, or the like. In addition, the sensor unit 160 may include various types of sensors for acquiring physiological data of the user. The physiological data of the user may include, in one example, heart rate, blood pressure, body temperature, respiration, eye movement, galvanic skin response, myoelectric potential, electroencephalogram, or the like.

### <<1.5. Server 20 According to Present Disclosure>>

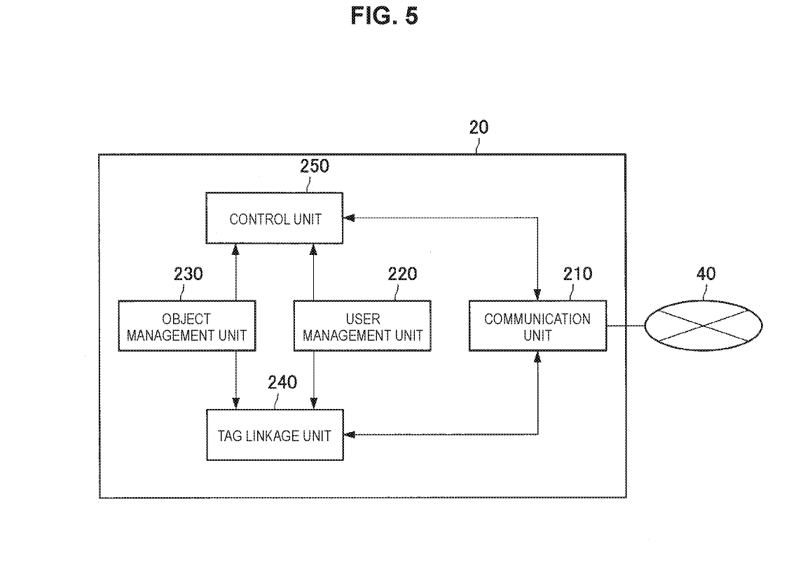

The server 20 according to the present disclosure is now described in detail. As described above, the server 20 according to the present disclosure has the function of acquiring position information from the real object 30 and updating the position information of the real object 30 held by the server 20. In addition, the server 20 executes various processing corresponding to the mode of an application to be provided while communicating with the information processing device 10. The server 20 according to the present disclosure may include a plurality of information processing devices or may be made redundant or virtualized. The configuration of the server 20 can be changed appropriately depending on conditions regarding the specification or operation of the application. A functional configuration example of the server 20 according to the present disclosure is now described with reference to FIG. 5.

### (Communication Unit 210)

A communication unit 210 has a function of performing information communication with the information processing device 10 or the real object 30. Specifically, the communication unit 210 acquires position information from the real object 30, and transmits the position information of the real object 30 and the tag information associated with the real object 30 to the information processing device 10. In addition, the communication unit 210 receives requests for various processing from the information processing device 10, and transmits the processing result corresponding to the mode of an application to the information processing device 10.

### (User Management Unit 220)

A user management unit 220 has a function of managing information related to the information processing device 10 and information related to the user who uses the information processing device 10. The user management unit 220 may be a database that stores the information related to the information processing device 10 and the user. The user management unit 220 stores, in one example, the position information of the information processing device 10, the identification information of the user, or the like. In addition, the user management unit 220 manages various types of information regarding the information processing device 10 and the user depending on the mode of the application.

An object management unit 230 has a function of managing information related to the real object 30. The object management unit 230 may be a database that stores information related to the real object 30. The object management unit 230 stores, in one example, the position information of the real object 30 and the tag information associated with the real object 30. In addition, the object management unit 230 stores various types of information regarding the real object 30 depending on the mode of the application.

### (Tag Linkage Unit 240)

A tag linkage unit 240 has a function of linking the real object 30 with the tag information. The tag linkage unit 240 links the identification information of the real object 30 that is acquired from the information processing device 10 with the newly set tag information, and stores it in the object management unit 230. In a case where the server 20 has a function related to the new tag information setting, the tag linkage unit 240 may link the tag information acquired using the function with the target real object 30.

### (Control Unit 250)

A control unit 250 has a function of controlling each component of the server 20 and causing the components to execute their own processing. The control unit 250 controls the user management unit 220 and the object management unit 230, in one example, on the basis of a request related to registration for new information from the information processing device 10 or the real object 30. In addition, the control unit 250 executes various processing corresponding to the mode of an application to be provided.

Although the functional configuration example of the server 20 according to the present disclosure is described above, the server 20 according to the present disclosure is not limited to the above example, and may further have a configuration other than that illustrated in FIG. 5. In one example, the server 20 may have a function of estimating tag information held by the information processing device 10 or filtering the tag information. In this case, the server 20 is capable of executing the processing by acquiring information necessary for the processing from the information processing device 10. The function of the server 20 can be changed depending on the mode of an application, the data amount of the tag information, or the like.

### <<1.6. Real Object 30 According to Present Disclosure>>

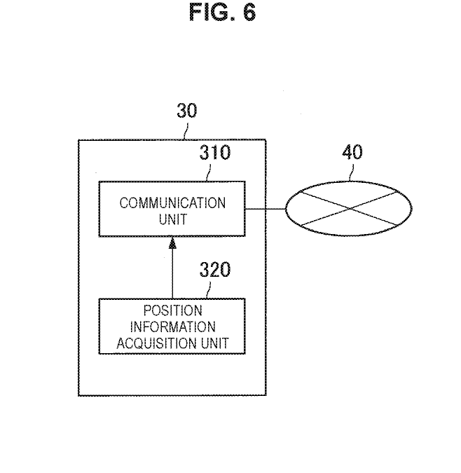

The real object 30 according to the present disclosure is now described in detail. The real object 30 according to the present disclosure can be defined as a moving real object such as vehicle or a real object that is movable by a third party. A functional configuration of the real object 30 according to the present disclosure is now described with reference to FIG. 6.

### (Communication Unit 310)

A communication unit 310 has a function of performing information communication with the server 20 or the information processing device 10. Specifically, the communication unit 310 transmits position information of the real object 30, which is acquired by a position information acquisition unit 320 to be described later, to the server 20. Moreover, the transmission of the position information to the server 20 may be performed periodically or irregularly. In the case where the transmission of the position information is performed irregularly, the information may be transmitted at the timing when the position information of the real object 30 is changed. In addition, the communication unit 310 may have a function of transmitting identification information, position information, or the like of the real object 30 to the information processing device 10 using short-range wireless communication. The short-range wireless communication may include communication by Bluetooth (registered trademark) or radio frequency identification (RFID).

### (Position Information Acquisition Unit 320)

The position information acquisition unit 320 has a function of acquiring the position information of the real object 30. The position information acquisition unit 320 acquires the position information of the real object 30 using, in one example, GPS, Wi-Fi, or the like.

### <<1.7. Modification of Functional Configuration According to Present Disclosure>>

The control of the tag display using the information processing device 10, the server 20, and the real object 30 according to the present disclosure is described above. The functional configuration described above is merely an example, and can be changed appropriately depending on the mode of an application to be provided. In one example, the position information of the real object 30 may be transmitted to the server 20 from the information processing device 10 that identifies the real object. The identification of the real object 30 by the information processing device 10 may be achieved by acquisition of identification information using a QR code (registered trademark) or by using image recognition technology. In addition, in one example, in a case where the real object 30 is a person holding a device capable of acquiring position information, the communication unit 310 of the real object 30 can perform information communication using intra-body communication with the communication unit 110 of the information processing device 10.

Embodiments according to the present disclosure using the information processing device 10, the server 20, and the real object 30 mentioned above are described below in detail.

### 2. First Embodiment

### 2.1. Overview of Battle Game According to First Embodiment

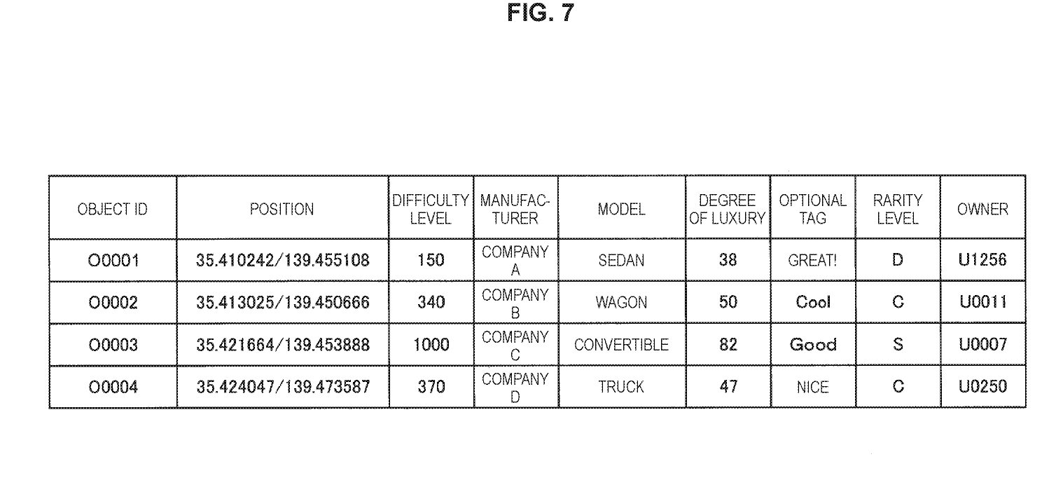

A battle game according to a first embodiment of the present disclosure is now described with reference to FIGS. 7 to 18. The battle game according to the present embodiment is a contest game that targets the real object 30. The users are divided into a plurality of teams, which are competing for the real objects 30 around the world and competing for victory or defeat at points acquired by each team. Moreover, the following description will be given of the real object 30 to be contested by taking a vehicle as an example.

The user who participates in the game first decides a team to participate at the time of user registration. Moreover, the team to participate may be decided by the server 20 that performs the user registration processing. The user can check the tag display associated with the real object 30 through the information processing device 10 such as HMD and launch an attack against the real object 30 of the opponent team.

The users have individual physical strengths and attack powers (status). In addition, the real object 30 is also associated with the tag information such as acquisition difficulty level or rarity level. The battle's victory or defeat is determined depending on the user who launches an attack, the status of the user who owns the real object 30, and the tag information of the real object 30. In this regard, in a case where the user who launches an attack wins, the user can take away the target real object 30 from the original owner. In addition, a user who wins the battle, as a privilege, may rise in status or may be given an item or the like available for the game. Furthermore, the user who wins the battle can set a new acquisition difficulty level in the real object 30 in exchange for the user's status. In addition, the user who wins the battle can set an optional tag to be associated with the real object 30. A detailed description of the battle will be given later.

Moreover, the points acquired by each team are obtained from the sum of the acquisition difficulty levels of the real objects 30 owned by the users belonging to each team. The points acquired by each team are counted every predetermined period such as week, month, or the like, and the team's victory or defeat may be determined for each such period.

### 2.2. Example of Information Managed by Server 20

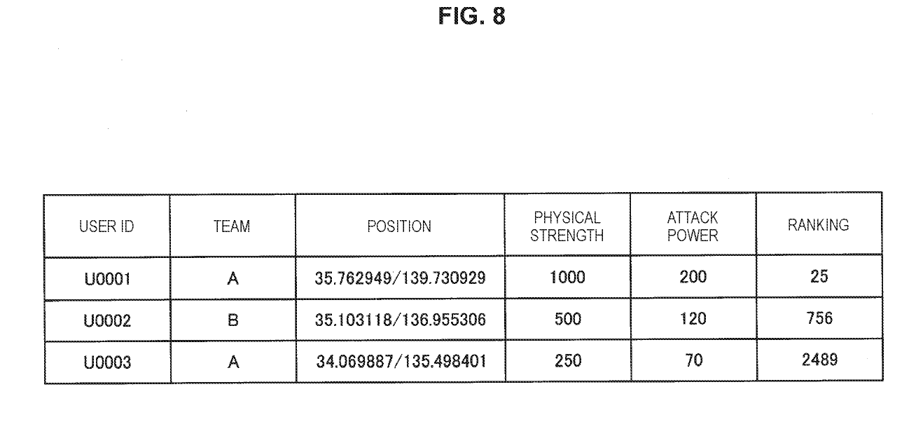

Various types of information used in the battle game according to the present embodiment are now described with reference to FIGS. 7 and 8. FIG. 7 illustrates an example of information related to the real object 30 managed by the object management unit 230 of the server 20. Referring to FIG. 7, the object management unit 230 manages the tag information such as acquisition difficulty level, manufacturer, model, degree of luxury, optional tag, rarity level, or the like in association with identification information and position information of the real object 30.

The acquisition difficulty level is an item corresponding to the physical strength of the real object 30. A user who launches an attack can subtract a numerical value obtained by multiplying a user's attack power by a random number from the acquisition difficulty level. If the acquisition difficulty level of the real object 30 is less than or equal to 0 from the result of the attack, the user who launches an attack gains the victory. The acquisition difficulty level is the tag information that can be set by the user who wins the battle, and the user can set a new acquisition difficulty level of the real object 30 in exchange for the user's status. The setting of high acquisition difficulty level makes it possible to eliminate or reduce the possibility of being taken away the real object 30 when an attack is launched from another user.

The manufacturer, model, and degree of luxury are product information related to the real object 30. The information may be information provided by a manufacturer that makes the real object 30. In addition, in the example illustrated in FIG. 7, the model is indicated by the type of vehicle such as sedan or wagon, but the information related to the model may be a product name developed by each manufacturer.

The optional tag is tag information set by the user who owns the real object 30, and the user, who launches an attack, when winning the battle, can set it. The optional tag may be a simple message directed to another user.

The rarity level is a value indicating the scarcity of the real object 30. The rarity level may be calculated from, in one example, the number of real objects 30 of the same model, which are managed by the object management unit 230. In other words, the rarity level of the real object 30 having a small number of identical models with respect to the whole is set to high, and the rarity level of the real object 30 in which many identical models are registered is set to low. Moreover, in the example illustrated in FIG. 7, the rarity level is indicated by an alphabet. In this regard, the rarity level may be a value that decreases in the order of S>A>B>C>D>E. In addition, the rarity level may be represented by a numerical value.

The owner is an item indicating a user who owns the real object 30. Referring to FIG. 8, it can be seen that the real object 30 associated with the ID “00001” is owned by the user associated with the ID “U1256”.

The information related to the real object 30 managed by the object management unit 230 according to the present embodiment is described above. Moreover, the above-described information managed by the object management unit 230 may be distributed and stored in a plurality of tables. In addition, information other than the above may be managed together. In one example, the object management unit 230 may manage the image information of a vehicle for each model of the real object 30.

Information related to the user (the information processing device 10) managed by the user management unit 220 according to the present embodiment is now described. FIG. 8 illustrates an example of user information managed by the user management unit 220. Referring to FIG. 8, the user management unit 220 stores information related to a team, physical strength, attack power, and ranking in association with identification information and position information of the user.

The team represents a force on the game to which the user belongs. In the example illustrated in FIG. 8, two teams of A or B are set, but there may be three or more teams, or in a case where the battle game is competed for each individual acquisition point, it is not necessarily set.

The physical strength and attack power indicate user status information. The physical strength decreases by counterattacks from the battle opponent, and when it is 0 or less, the user's defeat is decided. As described above, the attack power indicates the strength of taking away the value of the acquisition difficulty level of the real object 30 to be attacked.

The ranking is a value indicating a user ranking in the game. The ranking is determined on the basis of points acquired for each user. In addition, the ranking may be a personal ranking of acquired points in the team, or may be a personal ranking of points acquired in all teams.

The information related to the user (the information processing device 10) managed by the user management unit 220 according to the present embodiment is described above. Moreover, the above-described information managed by the user management unit 220 may be distributed and stored in a plurality of tables. In addition, information other than the above may be managed together. In one example, the user management unit 220 may further manage the user's status such as defense power or hit rate, to make the game more complicated.

### 2.3. Display Control of Information Regarding Battle Game

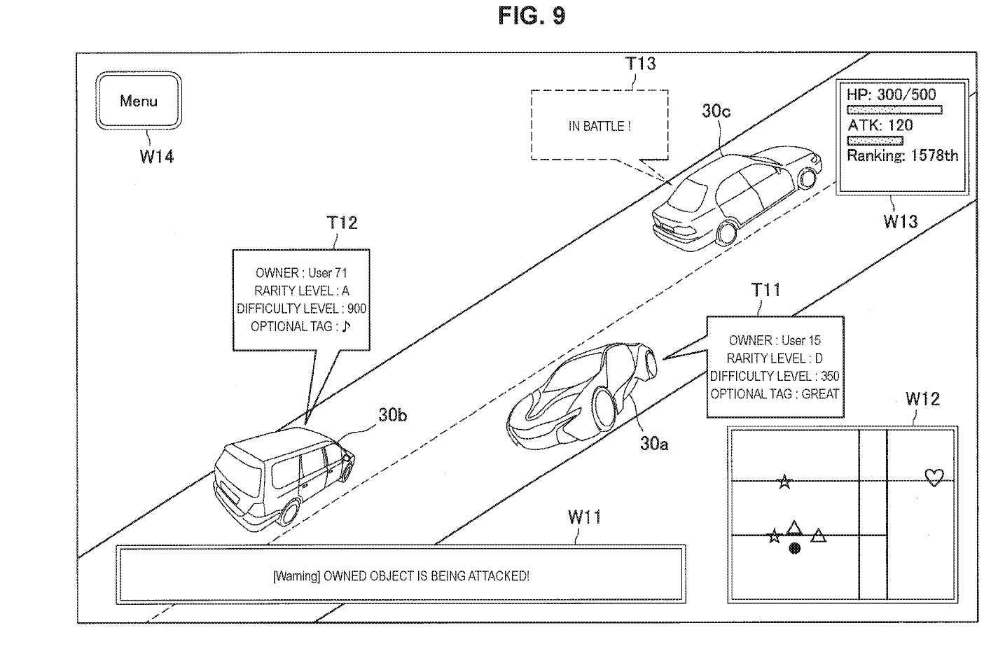

The overview of the battle game according to the present embodiment is described above. Then, display control of information regarding the battle game is described. FIG. 9 illustrates visual information obtained by the user through the information processing device 10. Referring to FIG. 9, the user perceives information on the real space including real objects 30a to 30c, tag displays T11 to T13 controlled by the display control unit 140, and windows W11 to W14. In this example, the real objects 30a to 30c are moving vehicles, and their position information is transmitted to the server 20.

Further, the tag displays T11 to T13 indicate tag displays associated with the real objects 30a to 30c, respectively. The tag displays T11 to T13 are controlled by the display control unit 140. Moreover, the display control unit 140 may acquire a change in the position information of the real objects 30a to 30c from the server 20 and control the display positions of the tag displays T11 to T13. In addition, the display control unit 140 may control the display positions of the tag displays T11 to T13 using image recognition technology such as SLAM on the basis of the information related to the real objects 30a to 30c that is acquired from the sensor unit 160.

The tag displays T11 to T13 illustrated in FIG. 9 are now described in detail. The tag displays T11 to T13 are generated on the basis of the tag information associated with the real object 30. Referring to the tag display T11, the owner, rarity level, difficulty level, and optional tag of the real object 30a are displayed as text information. The user is able to determine whether to launch an attack against the real object 30a by checking each item of information described above.

Then, referring to the tag display T12, the same item as the tag display T11 is displayed on the tag display T12, but the background of the tag display T12 is displayed in a format different from the tag display T11. As described above, the display control unit 140 may change the display format of the tag display depending on the tag information associated with the real object 30. In this example, the display control unit 140 controls the display format of the tag display depending on the rarity level that is set in the real object 30. It can be seen that the rarity level of the real object 30a is D while the rarity level of the real object 30b is A, as compared to the tag displays T11 and T12. The user is able to recognize intuitively that the rarity level of the real object 30b is higher by checking the display format of the tag display T12. The display format of the tag display may include color, shape, size, pattern, or the like.

Then, referring to the tag display T13, unlike the tag displays T11 and T12, text information “IN BATTLE!” is displayed. In this example, this message indicates that the real object 30c is being attacked by another user (in battle). As described above, the display control unit 140 is capable of acquiring a situation of processing regarding the real object 30 from the server 20 to control the tag display. In addition, as illustrated in FIG. 9, the display control unit 140 may indicate to the user that the real object 30c is not an attack target by controlling the display format of the tag display T13.

Further, the display control unit 140 according to the present embodiment may have a function of filtering tag information to be displayed depending on various conditions such as setting and state of the user. In one example, in a case where a predetermined rarity level is set as a condition for the user to display the tag information, the display control unit 140 may display only the tag display regarding the real object 30 associated with the rarity level having a predetermined value or more.

Further, the display control unit 140 may filter the tag information to be displayed on the basis of the information related to the user's emotion that is acquired by the sensor unit 160. In one example, in a case where the information related to the user's emotion indicates the excited state of the user, the display control unit 140 may perform display control in such a manner to display only the tag information associated with a red-colored vehicle. Moreover, examples of the information related to the user's emotion may include information related to heart rate, blood pressure, eye movement, or the like of the user.

Then, the windows W11 to W14 illustrated in FIG. 9 are described in detail. The windows W11 to W14 are areas for presenting information related to the battle game to the user. A message from the application to the user is displayed in the window W11. In this example, a message indicating that the real object 30 owned by the user is being attacked by another user is displayed in the window W11. As described above, the display control unit 140 is capable of displaying various kinds of information acquired from the server 20 while distinguishing them from the tag display associated with the real object 30.

The window W12 is an area for displaying the position information of the information processing device 10 and the real object 30 on a map. In this example, the position (user's position) of the information processing device 10 is indicated by a mark of black circle, and the position of the real object 30 is indicated by a mark of white triangle or white star. In this regard, the display control unit 140 may change the mark indicating the real object 30 depending on the rarity level of the real object 30. In one example, when the rarity level of the real object 30 is a predetermined rarity level or more, the display control unit 140 may cause the real object 30 to be displayed as a white star mark on the map. In addition, the display control unit 140 is capable of performing display control in such a manner to display information other than the real object 30 that is acquired from the server 20 on the map. In this example, an item used in the battle game is shown on the map with a heart-shaped mark. The item used in the battle game may be, in one example, one that restores the user's physical strength.

The window W13 is an area for displaying the information related to the user (the information processing device 10) such as the status including the user's physical strength or attack power, the ranking, or the like. The display control unit 140 is capable of causing various kinds of information related to the user that is acquired from the server 20 to be displayed in the window W13. Moreover, in this example, the physical strength of the user is represented as HP, and the attack power is represented as ATK. The display control unit 140 may acquire information related to the team to which the user belongs from the server 20 and cause it to be displayed in the window W13.

The window W14 is an example of an icon used to perform transition to various control screens regarding the battle game. In this manner, the display control unit 140 may control a display interface for the user to perform the processing regarding the battle game. Moreover, it is conceivable that examples of the various control screens regarding the battle game include a screen for user information setting, a screen for communication with other users, or the like.

As described above, it is possible for the display control unit 140 according to the present embodiment to control display of the information related to the user (the information processing device 10) or the information on the processing related to the battle game, in addition to the tag information associated with the real object 30.

### 2.4. Simplified Display Information

Then, the control regarding simplification of the display information by the display control unit 140 is described. The display control unit 140 according to the present embodiment has a function of simplifying and displaying the tag information depending on various conditions. The simplification and displaying of the tag information makes it possible for the user to recognize intuitively the tag information associated with the real object 30. The display control unit 140 may simplify the display information, in one example, by using icons and a change in colors.

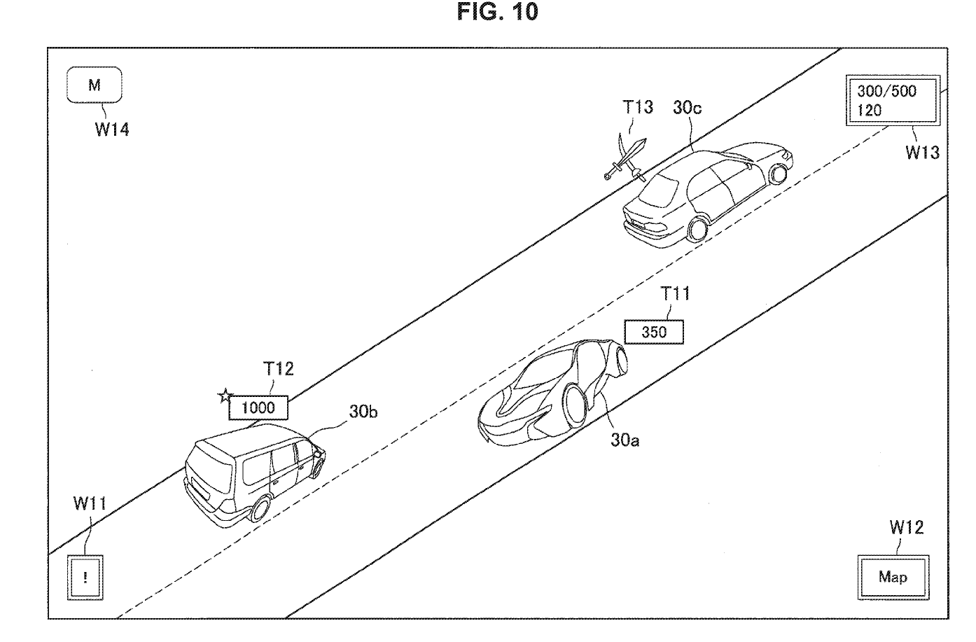

The simplification of the display information by the display control unit 140 is now described in detail with reference to FIG. 10. FIG. 10 illustrates information on the real space including the real objects 30a to 30c, tag displays T11 to T13 controlled by the display control unit 140, and windows W11 to W14, which are similar to the example illustrated in FIG. 9.

When comparing FIG. 10 with FIG. 9, it can be seen that the tag display T11 to T13 and the windows W11 to W14 in FIG. 10 are simplified in information as compared with the tag display T11 to T13 and the windows W11 to W14 in FIG. 9. The real object 30 according to the present embodiment is a moving vehicle, and the tag display is displayed while following the change of the position information of the real object 30. Thus, in a case where the moving speed of the real object 30 is fast, the real object 30 and the tag display will be likely to disappear from the user's field of view before the user checks contents of the tag display.

The display control unit 140 according to the present embodiment is capable of displaying the tag display while simplifying it on the basis of the moving speed of the real object 30 in consideration of the above situation. In this regard, the moving speed of the real object 30 may be a value calculated by the server 20 from the change of the position information of the real object 30, or may be a value calculated by the information processing device 10 from the information regarding the real object 30 that is acquired from the sensor unit 160.

Referring to FIG. 10, the tag display T11 displays only a numerical character, 350, indicating the difficulty level associated with the real object 30a. In addition, the tag display T12 displays a numerical character, 1000, indicating the difficulty level of the real object 30b and displays a star icon, which is similar to the tag display T11. In this example, the star icon indicates that the rarity level of the real object 30b is high. In addition, the tag display T13 displays an icon indicating battle in place of text display of a fact that battle is in progress. As described above, the display control unit 140 is capable of controlling the tag display in such a manner to convey intuitively information to the user while simplifying the amount of information to be displayed. In addition, the display control unit 140 may be intended to simplify the information by changing color of the tag display. In one example, the display control unit 140 may change the color of the tag display depending on, in one example, the value of the acquisition difficulty level. By performing this control, it is possible for the user to identify contents of the tag information with the color of the tag display even when the user fails to visually recognize a character in the tag display.

Moreover, the display control unit 140 is also capable of simplifying the information to be displayed on the basis of the moving speed of the user (the information processing device 10). By performing this control, it is possible to reduce the influence on the visual information of the real space perceived by the user to be small and to secure the safety at the time of movement of the user. In this event, the display control unit 140 may display the windows W11 to W14 while simplifying it in a similar manner to the tag displays T11 to T13. In addition, the display positions of the windows W11 to W14 may be controlled to move to a corner of the user's field of view. The moving speed of the user (information processing device 10) can be calculated on the basis of the information acquired from the sensor unit 160.

Furthermore, the display control unit 140 is also capable of simplifying the information to be displayed in consideration of the information amount of the tag information associated with the real object 30. In one example, in a case where the number of real objects 30 to be recognized is large, a case where the number of associated tag information is large, a case where the information amount of tag information is large, or other like cases, the display control unit 140 may display the tag display while simplifying it.

### 2.5. Specifying Real Object 30 to be Attacked

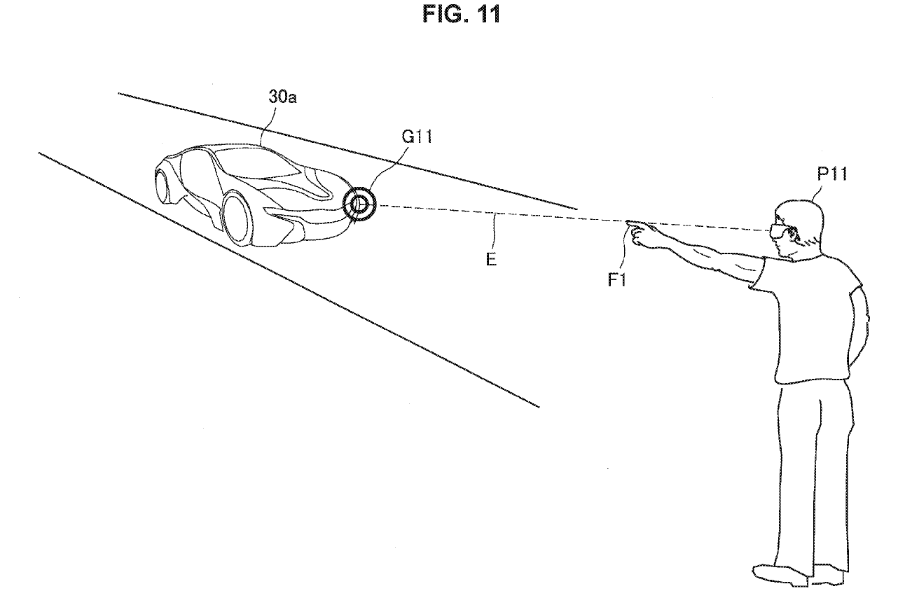

The information display control by the display control unit 140 according to the present embodiment is described above. Then, specifying the real object 30 to be attacked regarding the battle game according to the present embodiment is described with reference to FIG. 11.

In the battle game according to the present embodiment, a user who checks the tag display associated with the real object 30 that is a moving vehicle launches an attack against the real object 30, and the battle is started. The display control unit 140 according to the present embodiment has a function of specifying a real object 30 to be attacked on the basis of the information acquired from the sensor unit 160.

The display control unit 140 according to the present embodiment is capable of specifying the target real object 30 using various methods corresponding to the type of sensor included in the sensor unit 160. In one example, in a case where the sensor unit 160 includes a microphone, the display control unit 140 may specify the target real object 30 by using voice recognition. In this event, voice information to be input may be the user's readout of a name of the user who owns the real object 30 or a model name of the real object 30. In addition, in a case where the sensor unit 160 detects an input from a user on an input device such as a touch panel, the display control unit 140 may specify the target real object 30 on the basis of this input information.

Further, in a case where the sensor unit 160 detects information on the user's line of sight, the display control unit 140 may specify the target real object 30 on the basis of the information on the user's line of sight. In this event, the display control unit 140 is capable of specifying, on the basis of a fact that the user's line of sight is fixed to the real object 30 for a predetermined time or longer, the real object 30 as a target. In addition, in a case where the sensor unit 160 detects a gesture of the user, the display control unit 140 may specify the target real object 30 on the basis of information on the user's gesture. In one example, the display control unit 140 is capable of specifying, on the basis of a fact that the user's finger points to the real object 30 for a predetermined time or longer, the real object 30 as a target.

Furthermore, the display control unit 140 may specify the target real object 30 on the basis of both the information on the user's line of sight and the information on the gesture. FIG. 11 is a diagram illustrated to describe a case where the real object 30 is specified on the basis of the information on the user's line of sight and the information on the gesture.

In an example illustrated in FIG. 11, a user P11 is pointing his/her line of sight to the real object 30a. Here, a line of sight E represents the line of sight of the user P11. In addition, a guide G11 is shown at the end of the line of sight E. The guide G11 is additional information to the user that the display control unit 140 controls on the basis of the information on the user's line of sight E detected by the sensor unit 160. The user P11 checks the guide G11 and specifies the real object 30a to be specified as a target by performing a gesture of moving the finger F1 in such a manner that the finger F1 overlaps the guide G11. Here, the display control unit 140 is capable of specifying the real object 30a as a target on the basis of the overlap of the finger F1 on the direction of the line of sight E. As described above, the use of both the user's line of sight information and the gesture information makes it possible for the display control unit 140 to specify a target more accurately.

### 2.6. Display Control of Specifying Real Object 30

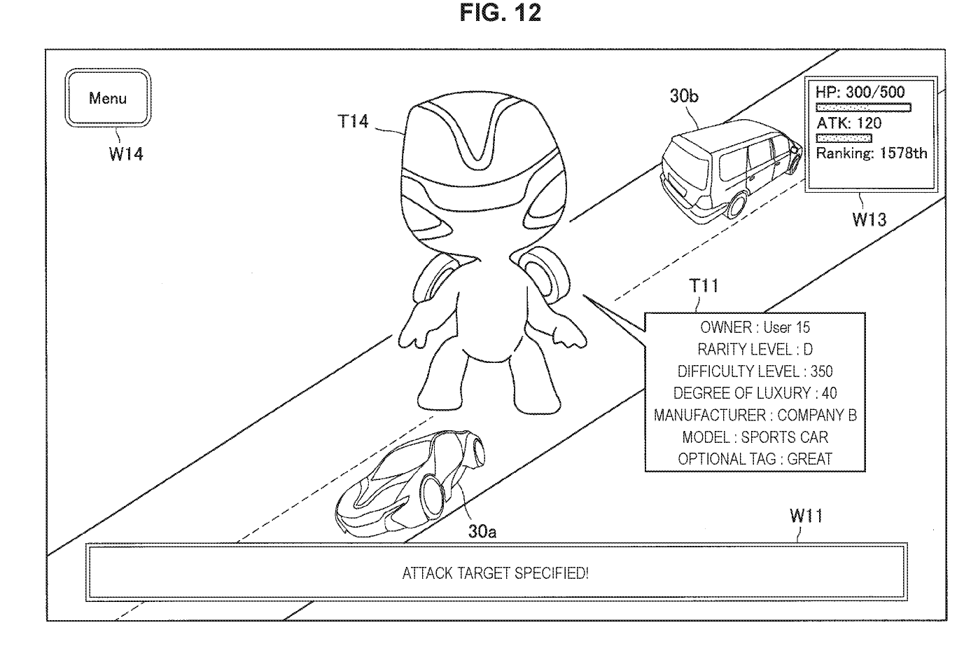

Then, the display control of specifying the real object 30 to be attacked is described with reference to FIG. 12. The display control unit 140 according to the present embodiment, when specifying the real object 30 to be attacked, newly displays a tag display that plays a role as an avatar of the real object 30. In addition, after specifying the real object 30, the display control unit 140 performs control in such a manner that the tag display associated with the real object 30 does not follow the real object 30. In other words, the display control unit 140 keeps the display position of the tag display in the state when the real object 30 is specified. The real object 30 according to the present embodiment is a moving vehicle, and so the real object 30 is likely to continue to move even after specifying it as a target, resulting in disappearing from the user's field of view. Thus, the display control unit 140, when specifying the real object 30 to be attacked, displays a new tag display that plays the role of avatar, and so it is possible for the user to continue the battle regardless of the subsequent move of the real object 30.

FIG. 12 illustrates a state in which the real object 30a is specified as an attack target in the situation illustrated in FIG. 9. With reference to FIG. 12, it can be seen that the positions of the real objects 30a and 30b are changed from the state of FIG. 9. In addition, the real object 30c illustrated in FIG. 9 is disappeared from the user's field of view.

Furthermore, in FIG. 12, a new tag display T14 is displayed at the center of the figure. The tag display T14 is a tag display that plays a role as an avatar of the real object 30a specified as an attack target. The tag display T14 that plays a role of an avatar may be displayed, as illustrated in FIG. 12, as an image obtained by adding modification or deformation to the real object 30a. In addition, the tag display T14 may be displayed as an animation for performing a change in response to an attack from the user or a counterattack from a battle opponent. The display control unit 140 is capable of acquiring the information stored in the object management unit of the server 20 and displaying it as the tag display T14. In addition, the tag display T14 may be an image that is processed on the basis of the image of the real object 30a photographed by the information processing device 10.

Further, as illustrated in FIG. 12, the display control unit 140 causes the tag display T11 associated with the real object 30a not to follow the movement of the real object 30a but to be displayed in association with the tag display T14 that plays the role of an avatar. In addition, in this event, the display control unit 140 may cause more contents to be displayed on the tag display T11, as compared with the case before specifying the real object 30a as a target. In the example illustrated in FIG. 12, the tag display T11 displays additional tag information related to degree of luxury, manufacturer, and model. In addition, the display control unit 140 may perform control in such a manner not to display a tag associated with a real object other than the real object 30a specified as an attack target. In addition, the display control unit 140 may cause the window W11 to display a fact that the real object 30a is specified as an attack target.

### 2.7. Control of Input Regarding Battle

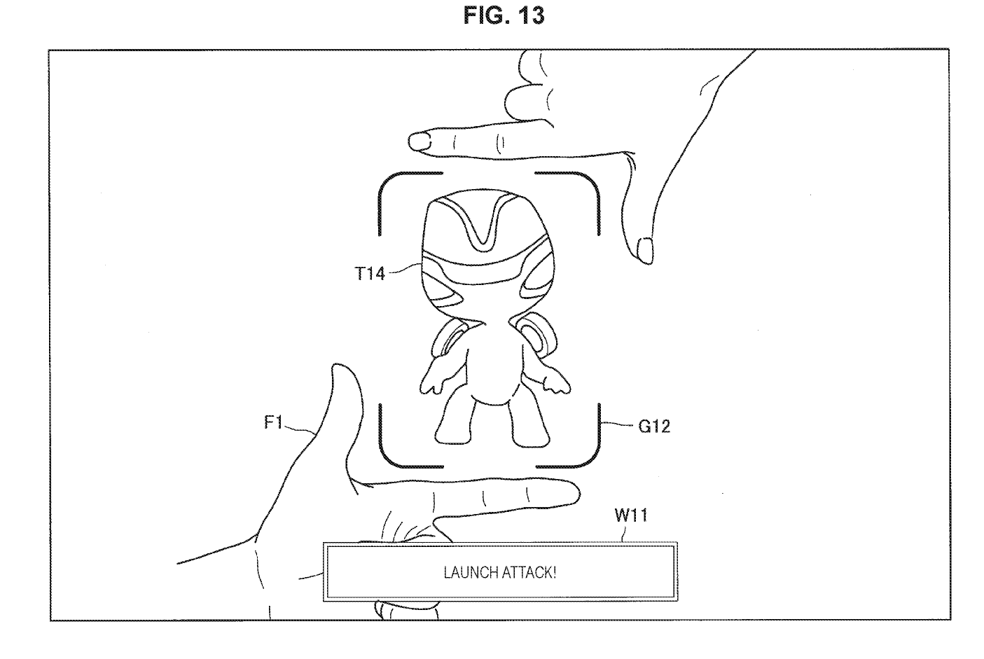

Then, the control of input regarding the battle of the present embodiment is described with reference to FIG. 13. The input regarding the battle of the present embodiment is controlled by the input control unit 150. More specifically, the input control unit 150 controls an input of an attack during a battle or setting of tag information after the battle is ended. The input control unit 150 according to the present embodiment controls various inputs on the basis of the information acquired from the sensor unit 160.

FIG. 13 illustrates an example in which the input control unit 150 recognizes the user's gesture as input information. FIG. 13 illustrates a tag display T14 as an avatar, a user's finger F1 surrounding the tag display T14, and a guide G12 displayed around the tag display T11. The guide G12 indicates additional information presented to the user that is controlled by the display control unit 140.

The input control unit 150 is capable of recognizing a battle command from the user on the basis of the user's gesture detected by the sensor unit 160. Here, the battle command may be an instruction to attack against the real object 30 by a predetermined gesture or a defense instruction against counterattack from a battle opponent. In the example illustrated in FIG. 13, the input control unit 150 recognizes the gesture surrounding the tag display T14 as an attack instruction.

The input control unit 150, when recognizing the battle command from the user, transmits contents of the battle command to the server 20 via the communication unit 110. In addition, in this event, the input control unit 150 may deliver the information on the recognized battle command to the display control unit 140. The display control unit 140 is capable of controlling the display including the guide G12 depending on the contents of the battle command. In addition, the display control unit 140 may cause the window W11 to display a fact that the battle command is recognized.

Moreover, FIG. 13 illustrates an example in which the input control unit 150 recognizes a battle command on the basis of the user's gesture information, but the input control unit 150 may recognize the battle command on the basis of information other than the gesture. The input control unit 150 may recognize the battle command, in one example, on the basis of the user's voice information acquired by the sensor unit 160. The recognition of the battle command by the input control unit 150 according to the present embodiment can be changed appropriately depending on the information acquired by the sensor unit 160.

The recognition of the battle command according to the present embodiment is described above. Then, the setting of the tag information after the battle is ended by the input control unit 150 is described. In the battle game according to the present embodiment, after the battle is ended, a user who wins the battle is able to set an optional tag or a new acquisition difficulty level as tag information to be associated with the real object 30.

The input control unit 150 is capable of setting the optional tag or the acquisition difficulty level on the basis of the input information from the user that is detected by the sensor unit 160, in a similar manner to the recognition of the battle command. In one example, the input control unit 150 may set the tag on the basis of the user's voice information.

Further, the input control unit 150 according to the present embodiment may estimate contents of tag information set by the user and may set it as new tag information. The input control unit 150 may estimate the contents of the tag information to be set on the basis of, in one example, a tendency of tag information set by the user in the past, user's gesture information, information related to the user's emotion that is acquired by the sensor unit 160, or the like. In a case where the tag information is estimated on the basis of the tendency of the tag information set by the user in the past, the input control unit 150 is capable of acquiring the information from the storage unit 120 and executing the estimation. In addition, the information related to the user's emotion may include information such as heart rate, blood pressure, eye movement, or the like of the user.

Further, the input control unit 150 may estimate a plurality of patterns of tag information to be set and present it as a setting candidate to the user. In this case, the input control unit 150 may set the contents corresponding to a pattern selected by the user as new tag information and deliver it to the target management unit 130. The target management unit 130 transmits the tag information accepted from the input control unit 150 to the server 20 in association with the target real object 30.

### 2.8. Control Flow According to First Embodiment

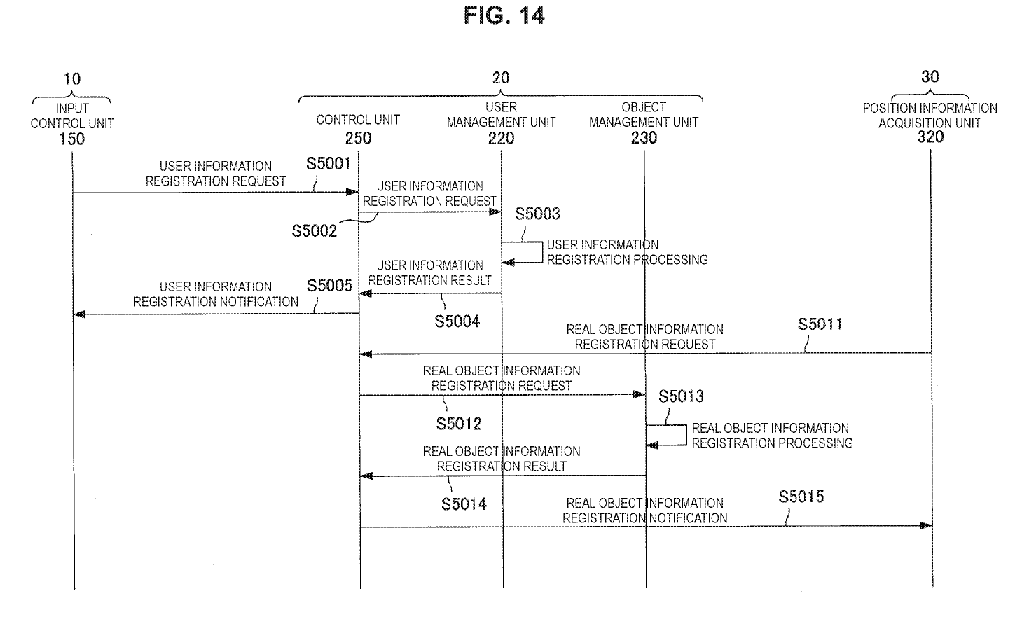

The characteristics of the information processing device 10, the server 20, and the real object 30 in the battle game according to the present embodiment are described above. Then, the control flow regarding the battle game of the present embodiment is described with reference to FIGS. 14 to 18. In the following description, it is assumed that communication between the information processing device 10, the server 20, and the real object 30 is performed via the communication units 110, 210, and 310 provided in the respective devices, and the illustration and description thereof will be omitted.

### (Procedure of New Registration of User Information)

A procedure of new registration of the user (information processing device 10) information is now described with reference to FIG. 14. With reference to FIG. 14, in new registration of user information, the input control unit 150 of the information processing device 10 first requests the control unit 250 of the server 20 to register the user information (S5001). In this event, the information transmitted from the input control unit 150 may include personal information of the user, position information of the information processing device 10, or the like. Subsequently, the control unit 250 of the server 20 requests the user management unit 220 to register the user information on the basis of the registration request of the acquired user information (S5002).

The user management unit 220, when receiving the request from the control unit 250, associates the information related to the user that is delivered from the control unit 250 with a new ID and performs registration processing of the user information (S5003). Subsequently, the user management unit 220 returns a result of the registration processing to the control unit 250 (S5004). In a case where the result of the registration processing that is acquired from the user management unit 220 is normal, the control unit 250 transmits a notification of user information registration to the information processing device 10 (S5005). Moreover, in a case where it is found that the result of the registration processing that is acquired from the user management unit 220 is abnormal, the control unit 250 may create a message corresponding to the result of the registration processing and transmit it to the information processing device 10.

### (Procedure of New Registration of Real Object 30)

Subsequently, the procedure of new registration of information on the real object 30 is described with reference to FIG. 14. Referring to FIG. 14, in the new registration of the real object 30, the position information acquisition unit 320 of the real object 30 first requests the control unit 250 of the server 20 to register the real object 30 (S5011). In this event, the information transmitted from the position information acquisition unit 320 may include information related to a manufacturer or model of the real object 30, position information of the real object 30, or the like. Subsequently, the control unit 250 of the server 20 requests the object management unit 230 to register the real object 30 on the basis of the acquired registration request of the real object 30 (S5012).

The object management unit 230, when receiving the request from the control unit 250, associates the information related to the real object 30 that is delivered from the control unit 250 with a new ID and performs registration processing of the real object 30 (S5013). Subsequently, the object management unit 230 returns a result of the registration processing to the control unit 250 (S5014). In a case where the result of the registration processing that is acquired from the object management unit 230 is normal, the control unit 250 transmits a registration notification to the real object 30 (S5015). Moreover, in a case where it is found that the result of the registration processing that is acquired from the object management unit 230 is abnormal, the control unit 250 may create a message corresponding to the result of the registration processing and transmit the message to the real object 30.

### (Procedure of Position Information Update of Information Processing Device 10)

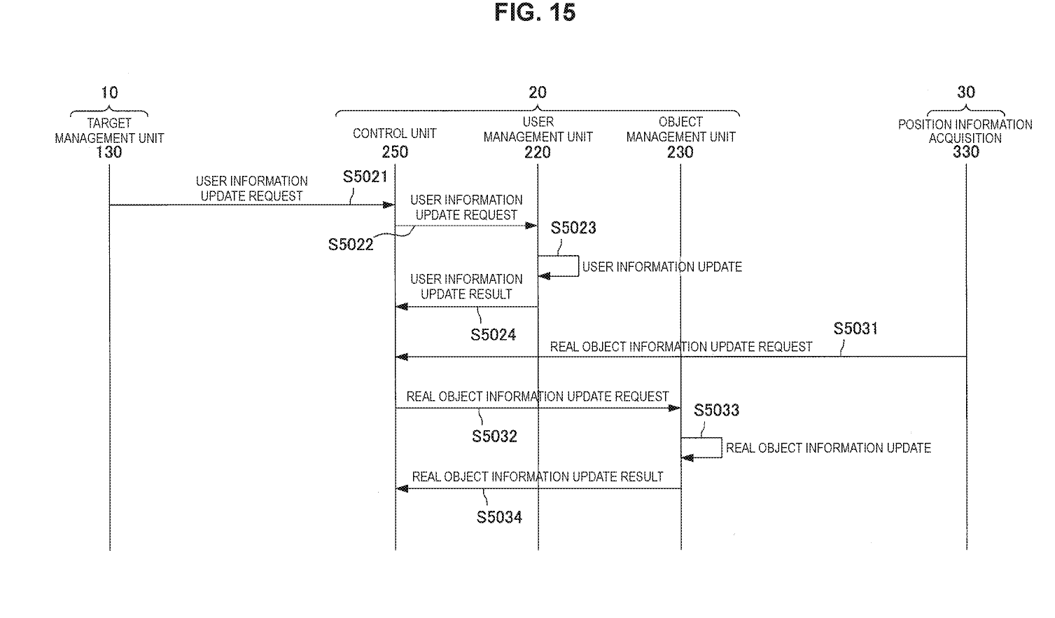

Then, the procedure of updating the position information of the information processing device 10 is described with reference to FIG. 15. The target management unit 130 of the information processing device 10 first requests the control unit 250 of the server 20 to update the location information (S5021). Subsequently, the control unit 250 requests the user management unit 220 to update the position information of the information processing device 10 on the basis of the acquired request (S5022).

The user management unit 220, when receiving the request, updates the position information of the information processing device 10 on the basis of the new position information of the information processing device 10 that is delivered from the control unit 250 (S5023). Subsequently, the user management unit 220 returns a result of the update processing to the control unit 250 and ends the processing (S5024). Moreover, in a case where it is found that the result of the update processing that is acquired from the user management unit 220 is abnormal, the control unit 250 may create a message corresponding to the result of the update processing and transmit the message to the information processing device 10.

### (Procedure of Position Information Update of Real Object 30)

Subsequently, the procedure of updating the position information of the real object 30 is described with reference to FIG. 15. The position information acquisition unit 320 of the real object 30 first requests the control unit 250 of the server 20 to update the position information (S5031). Then, the control unit 250 requests the object management unit 230 to update the position information of the real object 30 on the basis of the acquired request (S5032).

The object management unit 230, when receiving the request, updates the position information of the real object 30 on the basis of the new position information of the real object 30 that is delivered from the control unit 250 (S5033). Subsequently, the object management unit 230 returns a result of the update processing to the control unit 250 and ends the processing (S5034). Moreover, in a case where it is found that the result of the registration processing that is acquired from the object management unit 230 is abnormal, the control unit 250 may create a message corresponding to the result of the update processing and transmit the message to the real object 30.

### (Procedure of Acquiring Tag Information)

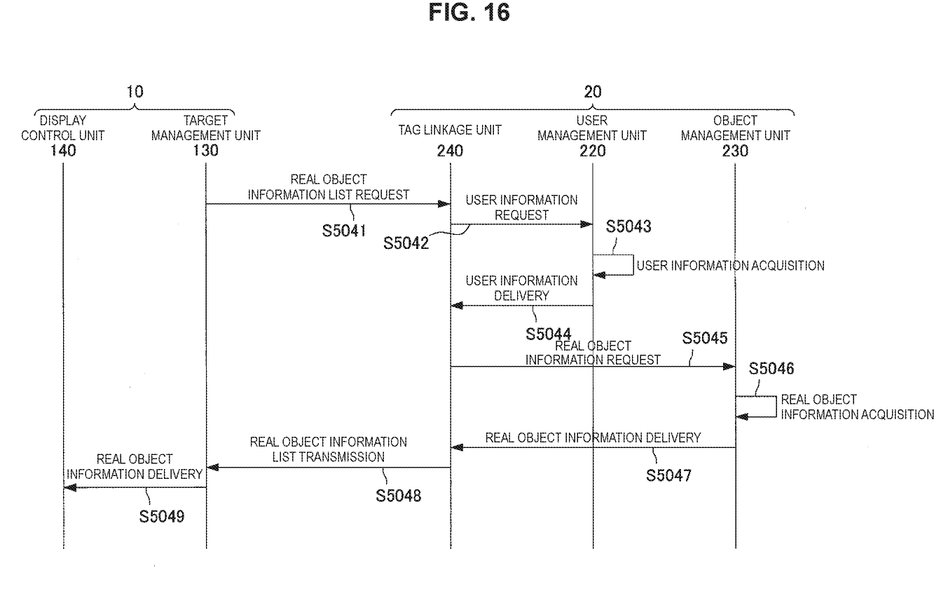

The procedure of acquiring tag information associated with the real object 30 is now described with reference to FIG. 16. The target management unit 130 of the information processing device 10 first requests an information list of the real object 30 from the tag linkage unit 240 of the server 20 (S5041). Then, the tag linkage unit 240 requests the user management unit 220 to acquire user information on the basis of the acquired request (S5042). The user management unit 220, when receiving the request, searches for user information on the basis of user identification information delivered from the tag linkage unit 240 (S5043). Subsequently, the user management unit 220 delivers the acquired user information to the tag linkage unit 240 (S5044).

Then, the tag linkage unit 240 requests the object management unit 230 to acquire information related to the real object 30 on the basis of the acquired position information of the user (the information processing device 10) (S5045). The object management unit 230, when receiving the request, searches the information of the real object 30 existing in the vicinity of the information processing device 10 on the basis of the position information of the information processing device 10 that is delivered from the tag linkage unit 240 (S5046). Subsequently, the object management unit 230 delivers the acquired information of the real object 30 to the tag linkage unit 240 (S5047).

Then, the tag linkage unit 240, when acquiring the information of the real object 30, transmits the acquired information list of the real object 30 to the target management unit 130 of the information processing device 10 (S5048). Moreover, in a case where it is found that the result of the information acquisition of the real object 30 that is acquired from the object management unit 230 is abnormal, the control unit 250 may create a message corresponding to the information acquisition result and transmit the message to the information processing device 10. Then, the target management unit 130 delivers the acquired information list of the real object 30 to the display control unit 140 (S5049), and ends the processing.

The procedure of acquiring the tag information associated with the real object 30 is described above. As described above, the server 20 is capable of acquiring the information of the real object 30 existing near the information processing device 10 on the basis of the position information of the information processing device 10. This processing makes it possible to achieve an effect of reducing the information amount of the real object 30 that the server 20 transmits to the information processing device 10.

### (Procedure of Controlling Battle)

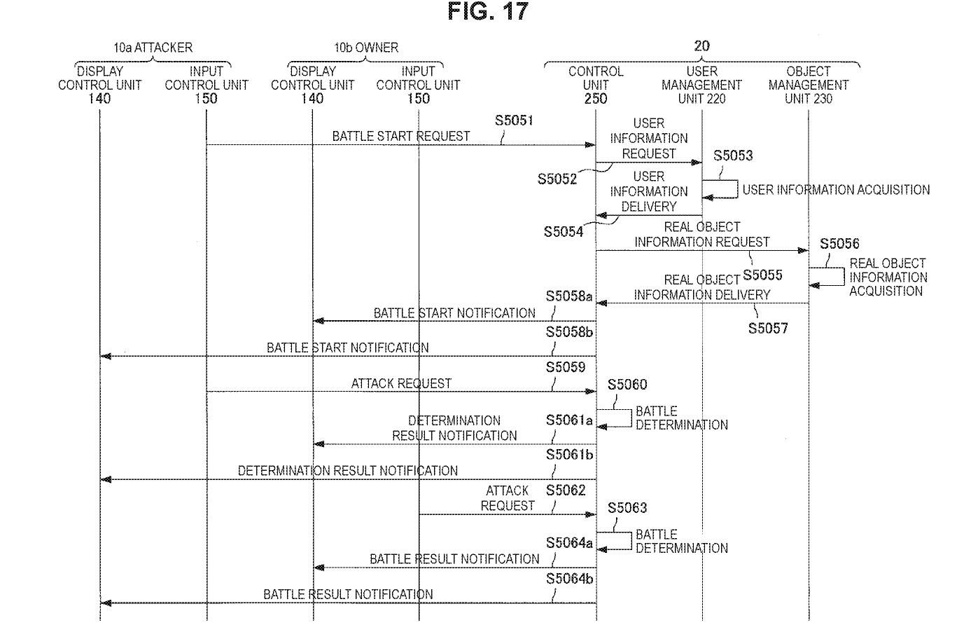

Then, the procedure of controlling the battle according to the present embodiment is described with reference to FIG. 17. A user who launches an attack (attacker) on the real object 30 first makes an input to instruct an information processing device 10a to start a battle. The input control unit 150 of the information processing device 10a that recognizes the start instruction of the battle requests the control unit 250 of the server 20 to start the battle (S5051).

Then, the control unit 250 requests the user management unit 220 to acquire information related to the attacker and the owner of the real object 30 set as an attack target (S5052). The user management unit 220, when receiving the request, searches for information on the user on the basis of the user identification information delivered from the control unit 250 (S5053). In this event, the acquired user information includes status information of the attacker and the owner. Subsequently, the user management unit 220 returns the acquired user information to the control unit 250 (S5054).

Then, the control unit 250 requests the object management unit 230 to acquire the information on the real object 30 to be the attack target (S5055). The object management unit 230, when receiving the request, searches for the information on the real object 30 on the basis of the identification information of the real object 30 that is delivered from the control unit 250 (S5056). In this time, the information to be acquired includes the acquisition difficulty level or rarity level associated with the real object 30. Subsequently, the object management unit 230 returns the acquired information related to the real object 30 to the control unit 250 (S5057).

In a case where the acquisition of the user information and the information related to the real object 30 is normally completed, the control unit 250 notifies the display control unit 140 of the information processing device 10 owned by the attacker and the owner of the start of the battle (S5058a and S5058b). Then, the input control unit 150 of the information processing device 10a owned by the attacker recognizes the attack instruction on the basis of the input by the user and requests the control unit 250 of the server 20 to perform the attack processing (S5059). The control unit 250, when receiving the attack request, performs the battle determination on the basis of the attack (S5060). Specifically, the control unit 250 performs processing of subtracting a value obtained by multiplying the attack power of the attacker by a random number from the acquisition difficulty level of the real object 30 to be the attack target. Here, the description will be continued assuming that the acquisition difficulty level of the real object 30 does not become 0 or less after the processing.

Subsequently, the control unit 250 transmits the result of the battle determination to the display control unit 140 of the information processing device 10 of the attacker and the owner (S5061a and S5061b). Then, the display control unit 140 of an information processing device 10b owned by the owner recognizes the attack instruction on the basis of the input by the user and requests the control unit 250 of the server 20 to perform the attack processing (S5062). Moreover, here, in a case where the attack request from the information processing device 10b fails to be checked within a predetermined time, the control unit 250 may perform the subsequent processing without waiting for the attack request. By performing the processing as described above by the control unit 250, even if the owner fails to participate in the battle game, it is possible for the attacker to continue the game.

Then, the control unit 250, when receiving the attack request, performs a battle determination based on the attack (S5063). Specifically, the control unit 250 performs processing of subtracting a value obtained by multiplying the attack power of the owner by a random number from the physical strength of the attacker. Here, the description will be continued assuming that the physical strength of the attacker does not become 0 or less after the processing.

Subsequently, the control unit 250 transmits the result of the battle determination to the display control unit 140 of the information processing device 10 of the attacker and the owner (S5064a and S5064b). Then, steps S5059 to S5063 described above are repeatedly processed until the physical strength of the attacker or the acquisition difficulty level of the real object 30 becomes 0 or less.

(Procedure of Setting Tag Information after Completion of Battle)

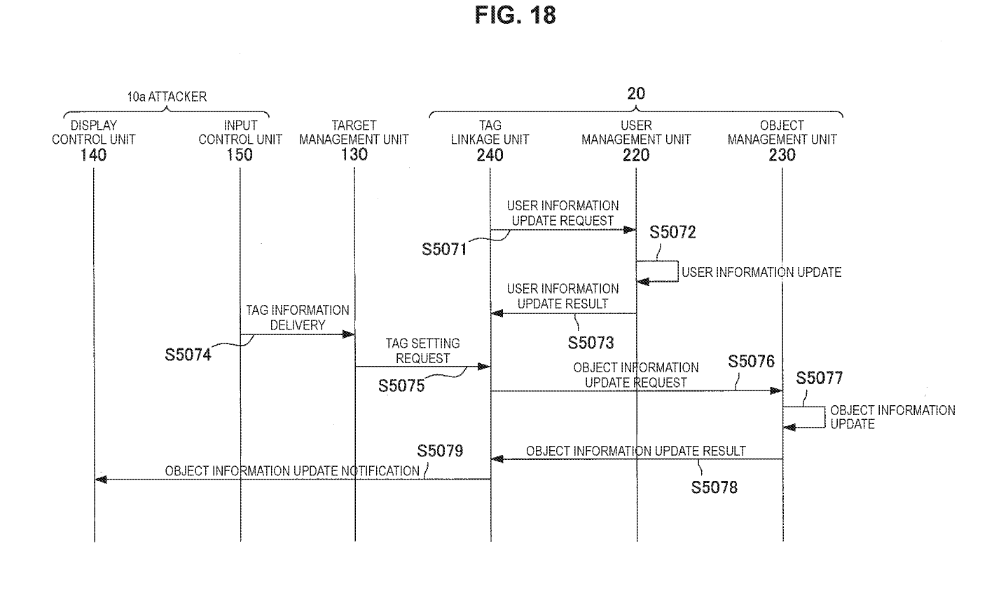

Then, the procedure of setting tag information after completion of a battle is described with reference to FIG. 18. Upon completion of the battle, the control unit 250 of the server 20 requests the user management unit 220 to update the user information on the basis of a result of the battle (S5071). Specifically, the control unit 250 requests the user management unit 220 to update the exhausted physical strength of the attacker with the battle. In addition, the control unit 250 requests to add the physical strength and attack power of the winner of the battle. In this event, the added value of the physical strength and the attack power may be calculated on the basis of the acquisition difficulty level or the rarity level of the real object 30 to be the attack target.

The user management unit 220, when receiving the request updates the user information on the basis of the information delivered from the control unit 250 (S5072). Subsequently, the user management unit 220 returns the update result of the user information to the control unit 250 (S5073). In this event, the control unit 250 may create a message corresponding to the result of the update and transmit the message to the information processing device 10 owned by the attacker and the owner.

Then, the winner of the battle sets tag information to be associated with the real object 30. Here, the description is given on the assumption that the attacker wins the battle. The attacker who is the winner of the battle inputs a new acquisition difficulty level and optional tag to be associated with the real object 30 to the information processing device 10a. The input control unit 150, when recognizing the input, delivers the setting of the tag information based on the recognized contents to the target management unit 130 (S5074). Here, the input control unit 150 may estimate new tag information on the basis of the past trends or information acquired from the sensor unit 160 and deliver it to the target management unit 130. The estimation of the tag information performed by the input control unit 150 makes it possible to reduce the input burden on the user. The target management unit 130 requests the control unit 250 of the server 20 to set tag information in association with the tag information delivered from the input control unit 150 and the target real object 30 (S5075).

The control unit 250, when receiving the tag setting request, requests the object management unit 230 to update the information of the real object 30 on the basis of contents of the request (S5076). The object management unit 230 updates the information on the real object 30 on the basis of the information delivered from the control unit 250. Specifically, the object management unit 230 sets the new acquisition difficulty level, the optional tag, and the owner of the real object 30 on the basis of the information delivered from the control unit 250 (S5077). Subsequently, the object management unit 230 returns the result of the update processing to the control unit 250 (S5078). In a case where the result of the update processing acquired from the object management unit 230 is normal, the control unit 250 transmits an update notification of the real object 30 to the display control unit 140 (S5079). Moreover, in a case where it is found that the result of the setting processing acquired from the object management unit 230 is abnormal, the control unit 250 may create a message corresponding to the result of the update processing and transmit the message to the display control unit 140.

### 2.9. Summary of First Embodiment

The battle game according to the first embodiment of the present disclosure is described above. As described above, the battle game according to the present embodiment is a contest game that targets the moving real object 30. The user is able to check the tag display associated with the real object 30 through the information processing device 10 and perform processing such as attack instruction. In addition, the user is able to set new tag information in the real object 30.

Moreover, in the present embodiment, the description is given of the real object 30 by taking a moving vehicle as an example, but the real object 30 according to the present embodiment is not limited to this example. The real object 30 according to the present embodiment may be a train or an airplane, or may be an animal equipped with a device for transmitting the positional information to the server 20. The functions of the information processing device 10, the server 20, and the real object 30 as described above allow the battle game of the present embodiment to be appropriately changed.

### 3. Second Embodiment

### 3.1. Overview of Bomb Game According to Second Embodiment

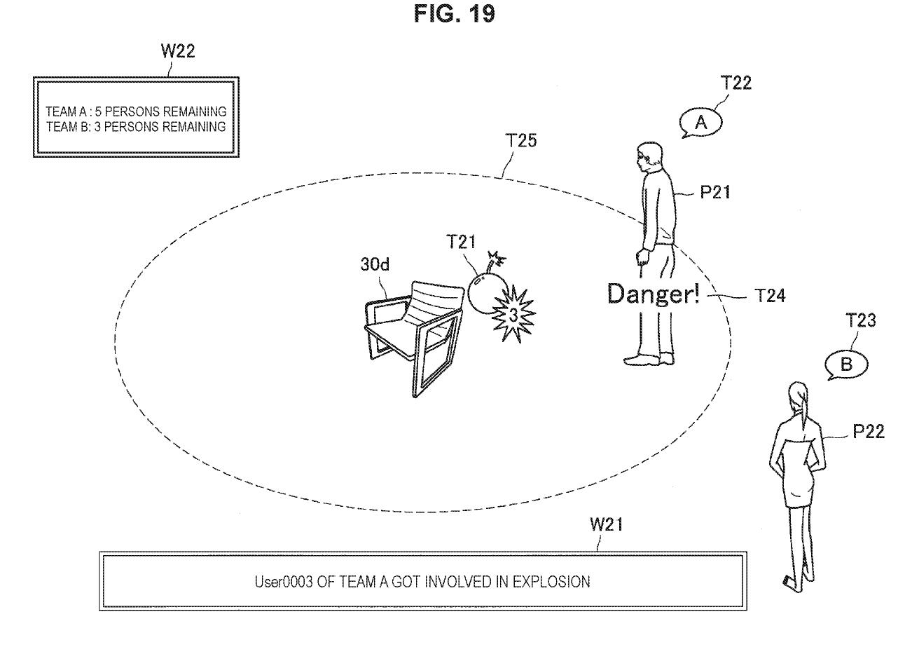

Then, a bomb game according to a second embodiment of the present disclosure is described with reference to FIG. 19. The bomb game according to the present embodiment is a competition game in which the real object 30 is caused to function as a time bomb by setting the time information to count down as the tag information in the real object 30.

It is assumed that the real object 30 causes an explosion when the associated time information is exhausted due to the countdown and a user within a predetermined range during the explosion drops out of the game as being involved in the explosion. The user is able to move the real object 30 before explosion of the real object 30 to escape the explosion or to cause the user of the opponent team to be involved in the explosion. The following description is given by focusing on the difference from the first embodiment, and the description of the common functions of the information processing device 10, server 20, and real object 30 will be omitted.

### 3.2. Details of Bomb Game According to Second Embodiment

The real object 30 according to the second embodiment is defined as an object that can be moved by the user. The real object 30 according to the present embodiment may be, in one example, a chair, a book, or a ball provided with a device for transmitting position information to the server 20. The users are divided into two teams, and move the real objects 30 to involve users of the opponent team in the explosion. A plurality of real objects 30 may be used in the game.

FIG. 19 is an image diagram of field-of-view information obtained by a user through the information processing device 10 in the bomb game according to the present embodiment. Referring to FIG. 19, the user perceives the real space information including a real object 30d or persons P21 and P22, and the tag information T21 to T25 and windows W21 to W22 controlled by the display control unit 140.

In the example illustrated in FIG. 19, the real object 30d is shown as a chair. In addition, the tag display T21 is associated with the real object 30d. The tag display 21 is controlled by the display control unit 140 on the basis of the time information associated with the real object 30d. In this example, the tag display T21 is displayed as an image imitating a bomb, and the number, 3, is shown on this image. This number indicates the number of seconds until the explosion, and the user is able to recognize the remaining time until the explosion of the real object 30d by checking the number.

Further, the tag display T25 indicating the range of the explosion is associated with the real object 30d. The display control unit performs display control of the tag display T25 on the basis of the tag information related to the explosion range associated with the real object 30.

The persons P21 and P22 indicate participants of the game. The tag displays T22 and T23 indicating the teams to which the respective persons P21 and P22 belong are associated with each other. In addition, the tag display T24 indicating text information “Danger!” is associated with the person P21. The tag display T24 is a tag display indicating a warning to the user located within the explosion range of the real object 30d. In this manner, in the bomb game according to the present embodiment, a person carrying the information processing device 10 can be treated as the real object 30.

The windows W21 and W22 are areas for presenting various kinds of information related to the game to the user. In the example illustrated in FIG. 19, a message indicating that another user is involved in an explosion is displayed in the window W21. In addition, the number of survivors for each team is displayed in the window W22. The display control unit 140 controls display of the windows W21 and W22 on the basis of the information acquired from the server 20.

When the time information associated with the real object 30d is exhausted due to the countdown, the control unit 250 of the server 20 acquires the position information of the user participating in the game from the user management unit 220, and makes a hit determination for each user on the basis of the tag information related to the explosion range associated with the real object 30d. In addition, the control unit 250 may perform processing of expanding the explosion range of the real object 30d depending on the number of times the user is involved in the explosion. The control unit 250 repeats the processing described above and terminates the game on the basis of the fact that the number of surviving users of any team is zero.

### 3.3. Summary of Second Embodiment

The bomb game according to the second embodiment of the present disclosure is described above. As described above, the bomb game according to the present embodiment is a competition game in which the real object 30 that can be moved by the user is regarded as a bomb. In the bomb game according to the present embodiment, a user who owns the information processing device 10 can be treated as the real object 30.

Moreover, in the present embodiment, the description is given of the real object 30 by taking a chair as an example, but the real object 30 according to the present embodiment is not limited to this example. The real object 30 according to the present embodiment may be a ball that is thrown by a user. The bomb game according to the present embodiment may be applied to a game like a snowball fight with an explosion range by using a ball as the real object 30.

### 4. Third Embodiment

### 4.1. Overview of Collection Game According to Third Embodiment

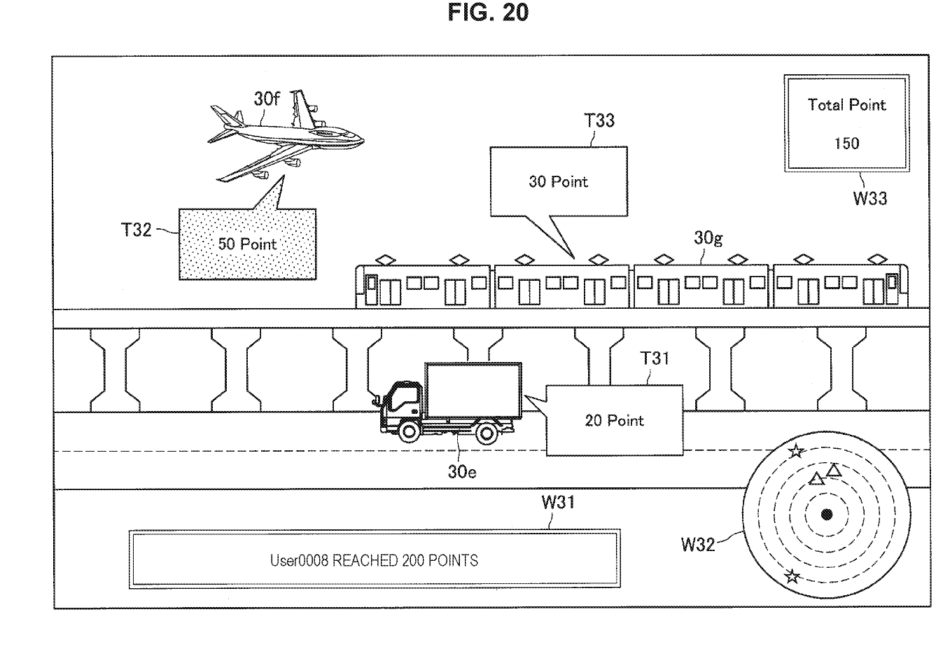

Then, a collection game according to a third embodiment of the present disclosure is described with reference to FIG. 20. The collection game according to the present embodiment is a game for collecting points by recognizing the target real object 30. It is possible for the user to acquire points associated with the real object 30 by recognizing various real objects 30. The user may compete for the total of acquired points, the time taken to acquire a predetermined point, or the like. The following description is given by focusing on the difference between the first and second embodiments, and the description of the common functions of the information processing device 10, server 20, and real object 30 will be omitted.

### 4.2. Details of Collection Game According to Third Embodiment

FIG. 20 is an image diagram of field-of-view information acquired by a user through the information processing device 10 in the collection game according to the present embodiment. Referring to FIG. 20, the user perceives the real space information including real objects 30e to 30g and the tag information T31 to T33 and windows W31 to W33 controlled by the display control unit 140.

In the example illustrated in FIG. 20, the real objects 30e to 30g to be collected are shown as a vehicle, an airplane, and a train, respectively. In addition, the tag displays T31 to T33 related to point information are displayed in association with the real objects 30e to 30g, respectively. In addition, the tag display T32 associated with the real object 30f is displayed in a display format different from that of the other tag displays T31 and T33. In this manner, the display control unit 140 may control the display format of the tag display on the basis of the amount of the points associated with the real object 30.

The windows W31 to W33 are areas for presenting various kinds of information related to the game to the user. In the example illustrated in FIG. 20, a message related to the state of points acquired by other users is displayed in the window W31. In addition, an image indicating the relative position between the user (the information processing device 10) and the real object 30 is displayed in the window W32. In W32, the black circle represents the position of the user, and the white triangle and the star mark represent the relative position of the real object 30 as viewed from the user. The display control unit 140 may indicate the real object 30 associated with points having a predetermined value or more with a star mark. In this manner, the third embodiment makes it possible to increase the difficulty level of the game by indicating the ambiguous position of the real object 30 on purpose, which is unlike the first embodiment.

In the collection game according to the present embodiment, in addition to the method of specifying the real object 30 that is described in the first embodiment, the acquired points may be added on the basis of the fact that the user actually rides or boards the real object 30. In this case, when the difference between the position information of the real object 30 and the position information of the user (the information processing device 10) is equal to or less than a predetermined value, the control unit 250 of the server 20 may determine that the user rides or boards the real object 30. In addition, the information processing device 10 held by the user who rides or boards the real object 30 may receive the identification information from the real object 30 using short-range wireless communication and transmit it to the server 20.

In a case where the acquired points are added on the basis of the riding or boarding on the real object 30, the highest point may be given to a user who first rode or boarded the real objects 30 among the users registered in the server 20. In addition, in a case of competing for the collection game according to the present embodiment by team, a bonus may be added to the acquired points depending on the number of users who rides or boards the real object 30 at the same time.

Furthermore, the collection game according to the present embodiment can interlock with a company's campaign. In one example, the user is able to obtain a higher acquisition point than usual by specifying a predetermined number or more of sales vehicles of a company that performs cooperation. In addition, the user may be able to obtain other advantages in addition to or in lieu of the acquired points. Here, the other advantage may be a product sold by a cooperating company, key information for downloading the content of another application, or the like.

### 4.3. Summary of Third Embodiment

The collection game according to the third embodiment of the present disclosure is described above. As described above, the collection game according to the present embodiment is a game in which the user competes for acquisition points obtained by recognizing the real object 30. In addition, in the collection game according to the present embodiment, it is also possible to give an acquisition point on the basis of the fact that the user actually rides or boards the real object 30.

Moreover, in the present embodiment, the description is given of the real object 30 by taking transportation such as a vehicle, a train, an airplane, or the like as an example, but the real object 30 according to the present embodiment is not limited to such example. The real object 30 according to the present embodiment may be, in one example, an animal equipped with a device that transmits position information to the server 20. The use of such an animal as the real object 30 allows the collection game according to the present embodiment to be held as an event such as a zoo.

### 5. Fourth Embodiment

### 5.1. Overview of Evaluation Function According to Fourth Embodiment

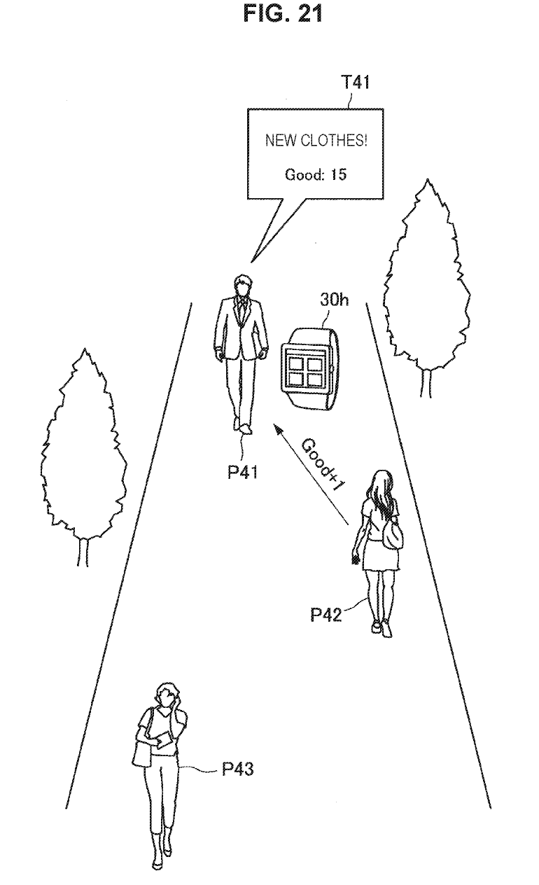

Then, an evaluation function according to a fourth embodiment of the present disclosure is described with reference to FIG. 21. In the evaluation function according to the present embodiment, the user evaluates the real object 30 or the owner of the real object 30 through the information processing device 10. In addition, the user is able to request another user to evaluate the matter concerning the requesting user through the information processing device 10, the server 20, and the real object 30. The following description is given by focusing on the difference from the first to third embodiments, and the description of the common functions of the information processing device 10, server 20, and real object 30 will be omitted.

### 5.2. Details of Evaluation Function According to Fourth Embodiment

FIG. 21 is an image diagram of field-of-view information acquired by the user through the information processing device 10 when utilizing the evaluation function according to the present embodiment. Referring to FIG. 21, the user perceives the information on the physical space including persons P41 to P43 and the tag information T41 controlled by the display control unit 140.

In the example illustrated in FIG. 21, a real object 30h is shown as a wearable device owned by the person P41. In addition, the tag information T41 is associated with the real object 30h. In this manner, the real object 30 according to the present embodiment may be an information device owned by the user. In addition, the real object 30 may be the same device as the information processing device 10. The display control unit 140 is capable of indirectly causing the tag display to follow the user by causing the tag display associated with the real object 30 held by the user to follow the real object 30.

In the tag display according to the present embodiment, information related to the evaluation of the real object 30 or the user who owns the real object 30 is displayed. In the tag display T41 illustrated in FIG. 21, two pieces of information are displayed, that is, text information “new clothes!”, and “Good: 15” indicating the number of evaluated persons. Here, the text information may be tag information set by the person P41 who owns the real object 30h. In the evaluation function according to the present embodiment, the user who owns the real object 30 is able to request another user to evaluate the matter concerning the user who owns the real object 30.

Further, the user is able to check the tag information related to the evaluation request set by another user through the information processing device 10 and input the evaluation. In the example illustrated in FIG. 21, the person P42 evaluates the person P41 (real object 30h) through the information processing device 10 (not shown). Moreover, the user is able to add a comment as tag information at the time of evaluation.

Further, in the evaluation function according to the present embodiment, filtering of the tag display may be performed in more detail. In a case where many users use the evaluation function, the amount of tag information controlled by the display control unit 140 becomes enormous, and it is difficult for the user to check the tag display desired to be checked. Thus, the user is able to set the information processing device 10 in such a manner that only tag information of interest is displayed. The information related to such setting may be stored in the storage unit 120. The display control unit 140 is capable of filtering the tag display to be displayed on the basis of the information set in the storage unit 120. In one example, in the example illustrated in FIG. 21, even in a case where the tag information is associated with the real object 30 (not shown) held by the person P43, the display control unit 140 may not necessarily display the tag information if the tag information does not correspond to the information set by the user.

Further, the display control unit 140 may perform filtering on the basis of the distance to the real object 30. In one example, the display control unit 140 is capable of causing only the tag information associated with the real object 30 existing at a predetermined distance to be displayed on the basis of the position information of the information processing device 10. Further, the display control unit 140 may control the information amount of the tag display on the basis of the distance to the real object 30. The display control unit 140 may cause more detailed information to be included in the tag display as the distance between the information processing device 10 and the real object 30 is shorter.

### 5.3. Summary of Fourth Embodiment

The evaluation function according to the fourth embodiment of the present disclosure is described above. As described above, the use of the evaluation function according to the present embodiment makes it possible for the user to evaluate the real object 30 or the owner of the real object 30 through the information processing device 10. In addition, the user is able to request another user to evaluate the matter concerning the requesting user himself through the information processing device 10, the server 20, and the real object 30.

Moreover, in the present embodiment, the description is given of the case where the individual uses the evaluation function as an example, but the use of the evaluation function according to the present embodiment is not limited to such example. In one example, it is also possible for a company to collect evaluation data from consumers in real time by using the evaluation function according to the present embodiment. In addition, the evaluation function according to the present embodiment is expected to cooperate with a campaign or the like that gives a bonus to the user who performs the evaluation.

### 6. Fifth Embodiment

### 6.1. Overview of Language Guidance According to Fifth Embodiment

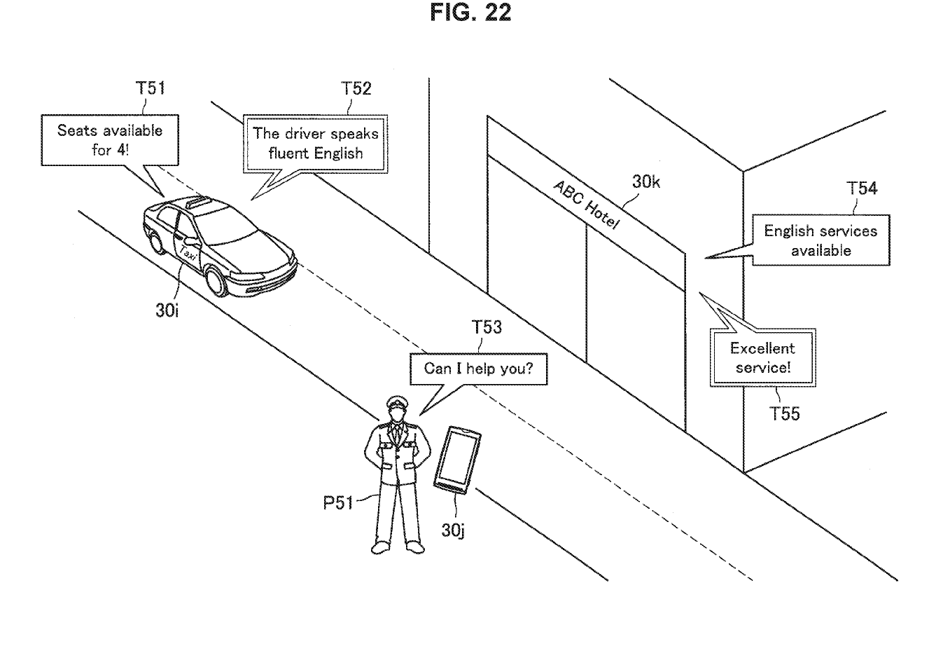

Then, the language guidance according to a fifth embodiment of the present disclosure is described with reference to FIG. 22. In the language guidance according to the present embodiment, the use of the tag information filtering function makes it possible to provide a foreign traveler or the like with information based on the user's language. In the following, the description is given by focusing on the difference from the first to fourth embodiments, and the description of the common functions of the information processing device 10, server 20, and real object 30 will be omitted.

### 6.2. Details of Language Guidance According to Fifth Embodiment

FIG. 22 is an image diagram of field-of-view information obtained by the user through the information processing device 10 when the language guidance according to the present embodiment is used. Referring to FIG. 22, the user perceives the real space information including a real object 30i and a person P51, and also perceives tag information T51 to T55 controlled by the display control unit 140.

Referring to FIG. 22, the real objects 30i shown as a taxi are associated with tag displays T51 and T52. In addition, the tag display T53 is associated with a real object 30j held by the person P51. In addition, the tag displays T54 and T55 are associated with a real object 30k installed in the signboard of the hotel.

As described above, in the language guidance according to the present embodiment, the use of the tag information filtering function makes it possible to filter the language type of the tag information to be displayed. In the example illustrated in FIG. 22, the user sets English as the filtering language in the information processing device 10 held by the user. The display control unit 140 controls the tag information to be displayed on the basis of the setting of the filtering language. For this reason, the tag information items T51 to T55 illustrated in FIG. 22 are all text information described in English.

The respective tag displays are now described in detail. The tag display T51 is a type of advertisement for a user who is an English speaker in association with the real object 30i shown as a taxi. The user who is an English speaker is able to know the contents of services that can be enjoyed by checking the tag display T51 associated with the moving real object 30i. In addition, the user who is an English speaker is able to recognize intuitively the taxi (the real object 30) associated with a tag display and distinguish between vehicles that can receive service by mother tongue. In addition, the tag display T52 is an evaluation comment associated with another user, and the user who is an English speaker is also able to select a vehicle to receive a service with reference to a comment from the other user.

The tag display T53 is associated with the real object 30j shown as a smartphone held by the person P51. Here, the person P51 may be police officer, security guard, or store staff. The user who is an English speaker is able to recognize that the person P51 can speak English by checking the tag display T53 associated with the real object 30j held by the person P51.

The tag display T54 is a type of advertisement for a user who is an English speaker in association with the real object 30k set in the signboard of the hotel. The user who is an English speaker is able to recognize it to be the hotel that can receive services in English by checking the tag display T54 associated with the real object 30k. Further, the tag display T55 is an evaluation comment associated with another user, and the user who is an English speaker is also able to select a hotel to stay with reference to the comment from the other user. Moreover, as illustrated in FIG. 22, the display control unit 140 may cause the tag information related to the evaluation from another user, such as the tag display T52 and T55, to be displayed in a display format different from the other tag information.

### 6.3. Summary of Fifth Embodiment

The language guidance according to the fifth embodiment of the present disclosure is described above. As described above, in the language guidance according to the present embodiment, the user of the tag information filtering function makes it possible to provide information based on the user's language.

Moreover, in the present embodiment, the case is described in which one type of language is set as the filtering language, but the language guidance according to the present embodiment is not limited to such example. In the language guidance according to the present embodiment, a plurality of languages may be set as the filtering language. In one example, it is also possible to apply Japanese language education to the users who are English speakers by setting the filtering language to English and Japanese.

### 7. Hardware Configuration Example

### <<7.1. Common Component>>

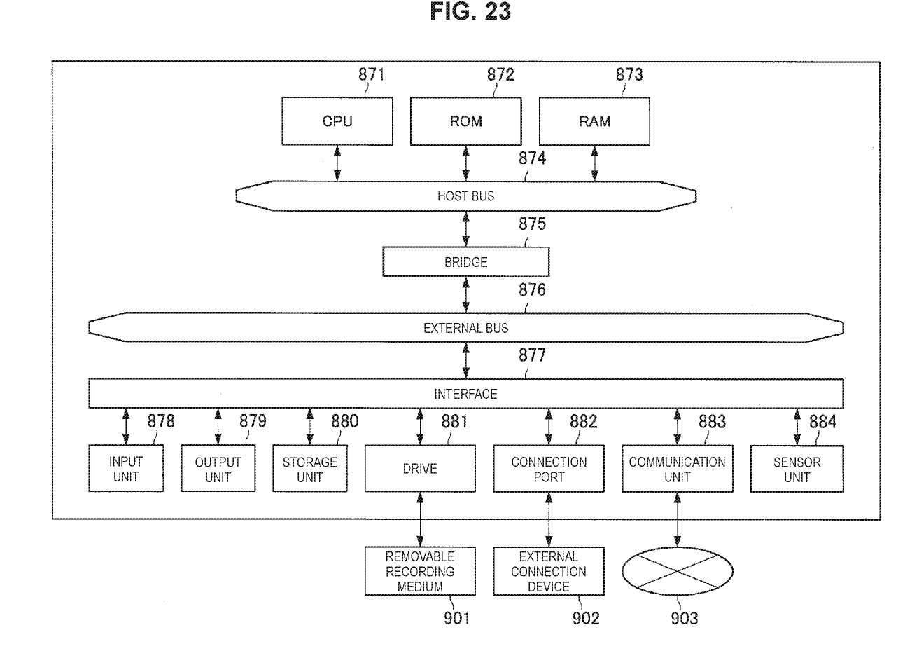

The hardware configuration example of the information processing device 10 and the server 20 according to the present disclosure is now described with reference to FIG. 23. The components common to the information processing device 10 and the server 20 are now described. FIG. 23 is a block diagram illustrating the hardware configuration example of the information processing device 10 and the server 20 according to the present disclosure.

### (CPU 871)

A CPU 871 functions as, in one example, an arithmetic processing unit or a control unit, and controls the overall operation of each component or a part thereof on the basis of various programs recorded in a ROM 872, a RAM 873, a storage unit 880, or a removable recording medium 901.

### (ROM 872 and RAM 873)

The ROM 872 is a means for storing programs to be fetched by the CPU 871, data used for calculation, or the like. The RAM 873 temporarily or permanently stores, in one example, programs to be fetched by the CPU 871, various parameters appropriately changing at the time of executing the program, or the like.

### (Host Bus 874, Bridge 875, External Bus 876, and Interface 877)

The CPU 871, the ROM 872, and the RAM 873 are mutually connected via, in one example, a host bus 874 capable of high-speed data transmission. On the other hand, the host bus 874 is connected to an external bus 876 having a relatively low data transmission speed via, in one example, a bridge 875. In addition, the external bus 876 is connected to various components via an interface 877.

### (Input Unit 878)

Examples of the input unit 878 include a mouse, a keyboard, a touch panel, a button, a switch, a lever, and the like. Further example of the input unit 878 includes a remote controller capable of transmitting a control signal using infrared rays or other radio waves (hereinafter referred to as a remote controller).

### (Output Unit 879)

An output unit 879 is a device capable of notifying visually or audibly the user of the acquired information, and examples thereof include a display device such as cathode ray tubes (CRTs), LCDs, or organic ELs, an audio output device such as speakers or headphones, a printer, a mobile phone, a facsimile, and the like.

### (Storage Unit 880)

The storage unit 880 is a device for storing various types of data. Examples of the storage unit 880 include a magnetic storage device such as hard disk drives (HDDs), a semiconductor storage device, an optical storage device, a magneto-optical storage device, and the like.

### (Drive 881)

A drive 881 is a device that reads out information recorded on the removable recording medium 901 such as a magnetic disk, an optical disk, a magneto-optical disk, or a semiconductor memory or writes information to the removable recording medium 901.

### (Removable Recording Medium 901)

The removable recording medium 901 is, in one example, a DVD medium, a Blu-ray (registered trademark) medium, an HD DVD medium, various kinds of semiconductor storage media, and the like. It may be apparent that the removable recording medium 901 may be, in one example, an IC card equipped with a contactless IC chip, an electronic device, or the like.

### (Connection Port 882)

A connection port 882 is a port for connection with an external connection device 902, and examples thereof include a universal serial bus (USB) port, an IEEE 1394 port, a small computer system interface (SCSI), an RS-232C port, or an optical audio terminal.

### (External Connection Device 902)

The external connection device 902 is, in one example, a printer, a portable music player, a digital camera, a digital video camera, an IC recorder, or the like.

### (Communication Unit 883)

A communication unit 883 is a communication device for connecting to a network 903, and examples thereof include a communication card for wired or wireless LAN, Bluetooth (registered trademark), or wireless USB (WUSB), a router for optical communication, a router for asymmetric digital subscriber line (ADSL), or a modem for various communication.

### <<7.2. Component Specific to the Information Processing Device 10>>

The components common to the information processing device 10 and the server 20 according to the present disclosure are described above. Subsequently, components specific to the information processing device 10 are described. Each of the components described below is not necessarily specific to the information processing device 10, and may be provided in the server 20.

### (Sensor Unit 884)

A sensor unit 884 includes a plurality of sensors and manages information acquired by each sensor. The sensor unit 884 includes, in one example, a geomagnetic sensor, an accelerometer, a gyro sensor, a barometer, and an optical sensor. Moreover, the hardware configuration shown here is an example, and some of the components may be omitted. In addition, the hardware configuration of the sensor unit 884 may further include components other than the components described here.

### (Geomagnetic Sensor)

The geomagnetic sensor is a sensor that detects geomagnetism as a voltage value. The geomagnetic sensor may be a triaxial geomagnetic sensor that detects geomagnetism in the X-axis direction, the Y-axis direction, and the Z-axis direction.

### (Accelerometer)

The accelerometer is a sensor that detects the acceleration as a voltage value. The accelerometer may be a triaxial acceleration sensor that detects the acceleration along the X-axis direction, the acceleration along the Y-axis direction, and the acceleration along the Z-axis direction.

### (Gyro Sensor)

The gyro sensor is a type of measuring instrument for detecting the angle and angular velocity of an object. The gyro sensor may be a triaxial gyro sensor that detects the speed (angular velocity) at which the rotation angle around the X-axis, the Y-axis, and the Z-axis changes as a voltage value.

### (Barometer)

The barometer is a sensor that detects ambient atmospheric pressure as a voltage value. The barometer can detect atmospheric pressure at a predetermined sampling frequency.

### (Optical Sensor)

The optical sensor is a sensor that detects electromagnetic energy such as light. Here, the optical sensor may be a sensor that detects visible light, or a sensor that detects invisible light.

### 8. Conclusion

As described above, the information processing device 10 according to the present disclosure has a function of controlling display of tag information associated with the moving real object 30. In addition, the information processing device 10 has a function of adding new tag information to the moving real object 30. In addition, the server 20 according to the present disclosure has a function of acquiring position information from the real object 30 and updating the position information of the real object 30 that is held in the server 20. In addition, the server 20 executes various processing corresponding to the mode of the application to be provided while communicating with the information processing device 10. Such a configuration makes it possible to change the display of the information associated with the moving real object depending on the position of the real object.

The preferred embodiment(s) of the present disclosure has/are described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

In one example, in the above embodiment, the display control unit 140 of the information processing device 10 controls display of tag information, but the present technology is not limited to this example. The display control of the tag information may be achieved by the server 20. In this case, the server 20 acquires the position information or direction information of the information processing device 10, and so the server 20 is capable of functioning as a display control unit that controls the display position of the tag information associated with the real object 30. In addition, the server 20 may control information display other than tag display to be displayed on the information processing device 10. In one example, the server 20 may perform control to cause the information processing device 10 to display a message related to the result of the processing by the server 20. Furthermore, the server 20 may perform filtering of a tag to be displayed or estimation of tag information to be newly set by the user in the real object 30 on the basis of the information acquired from the sensor unit of the information processing device 10.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An information processing device including:

a display control unit configured to control display of tag information managed in association with position information of a real object,

in which the display control unit controls the display of the tag information in such a manner that the display of the tag information is changed depending on a change in the position information of the real object.

(2)

The information processing device according to (1), further including:

a sensor unit including one or more sensors,

in which the display control unit controls a display position of the tag information depending on the change in the position information of the real object and a change in position information and direction information of the information processing device, the position information and the direction information being collected by the sensor unit.

(3)

The information processing device according to (1) or (2),

in which the display control unit controls the display position of the tag information in such a manner that the display of the tag information follows the real object.

(4)

The information processing device according to (2),

in which the display control unit controls the display of the tag information in such a manner that the display of the tag information is changed depending on a moving speed of the real object, the moving speed being collected by the sensor unit.

(5)

The information processing device according to any one of (2) to (4),

in which the display control unit limits display contents of the tag information on a basis of a fact that the moving speed of the real object exceeds a predetermined speed.

(6)

The information processing device according to any one of (1) to (5),

in which the display control unit, in a case of specifying the real object from information collected by the sensor unit, causes tag information playing a role as an avatar of the real object to be displayed and causes a display position of tag information associated with the real object to be kept.

(7)

The information processing device according to any one of (1) to (6),

in which the display control unit controls the display of the tag information in such a manner that the display of the tag information is changed depending on a distance between the real object and the information processing device.
(8)
   The information processing device according to any one of (1) to (7),

in which the display control unit controls display contents of the tag information on a basis of a fact that the distance between the real object and the information processing device exceeds a predetermined distance.

(9)

The information processing device according to any one of (1) to (8),

in which the display control unit performs filtering of tag information to be displayed depending on contents of the tag information.

(10)

The information processing device according to (2), further including:

a target management unit configured to manage the position information of the real object and the tag information in association with each other.

(11)

The information processing device according to (10), further including:

an input control unit configured to set contents of the tag information.

(12)

The information processing device according to (11),

in which the target management unit associates the tag information set by the input control unit with the real object.

(13)

The information processing device according to (11) or (12),

in which the input control unit sets contents estimated from user-related information collected by the sensor unit as the contents of the tag information, and

the information collected by the sensor unit includes user's line of sight, user's gesture, and user's emotion.

(14)

The information processing device according to (12),

in which the target management unit associates tag contents set by the input control unit with the real object specified from information collected by the sensor unit, and

the information collected by the sensor unit includes user's line of sight, user's gesture, voice information, and image information of the real object.

(15)

The information processing device according to (12),

in which the target management unit associates tag contents set by the input control unit with the real object specified using SLAM techniques from information collected by the sensor unit.

(16)

The information processing device according to (12),

in which the target management unit associates tag contents set by the input control unit with the real object specified from information regarding the real object that is collected using short-range wireless communication.

(17)

The information processing device according to any one of (1) to (16),

in which the information processing device is a head-mounted display.

(18)

An information processing method including:

controlling, by a processor, display of tag information managed in association with position information of a real object; and

controlling the display of the tag information in such a manner that the display of the tag information is changed depending on a change in the position information of the real object.

(19)

A program causing a computer to function as an information processing device including:

a display control unit configured to control display of tag information managed in association with position information of a real object,

in which the display control unit controls the display of the tag information in such a manner that the display of the tag information is changed depending on a change in the position information of the real object.

(20)

A server including:

an object management unit configured to manage an update of position information of a real object on a basis of the collected position information of the real object; and

a control unit configured to cause the position information of the real object and tag information managed in association with the position information of the real object to be transmitted to an information processing device.

### REFERENCE SIGNS LIST

10 information processing device
20 server
30 real object
110 communication unit
120 storage unit
130 target management unit
140 display control unit
150 input control unit
160 sensor unit
210 communication unit
220 user management unit
230 object management unit
240 tag linkage unit
250 control unit
310 communication unit
320 position information acquisition unit

1. An information processing device comprising:
a display control unit configured to control display of tag information managed in association with position information of a real object,
wherein the display control unit controls the display of the tag information in such a manner that the display of the tag information is changed depending on a change in the position information of the real object.

2. The information processing device according to claim 1, further comprising:
a sensor unit including one or more sensors,
wherein the display control unit controls a display position of the tag information depending on the change in the position information of the real object and a change in position information and direction information of the information processing device, the position information and the direction information being collected by the sensor unit.

3. The information processing device according to claim 2,
wherein the display control unit controls the display position of the tag information in such a manner that the display of the tag information follows the real object.

4. The information processing device according to claim 2,
wherein the display control unit controls the display of the tag information in such a manner that the display of the tag information is changed depending on a moving speed of the real object, the moving speed being collected by the sensor unit.

5. The information processing device according to claim 4,
wherein the display control unit limits display contents of the tag information on a basis of a fact that the moving speed of the real object exceeds a predetermined speed.

6. The information processing device according to claim 2,
wherein the display control unit, in a case of specifying the real object from information collected by the sensor unit, causes tag information playing a role as an avatar of the real object to be displayed and causes a display position of tag information associated with the real object to be kept.

7. The information processing device according to claim 2,
wherein the display control unit controls the display of the tag information in such a manner that the display of the tag information is changed depending on a distance between the real object and the information processing device.

8. The information processing device according to claim 7,
wherein the display control unit controls display contents of the tag information on a basis of a fact that the distance between the real object and the information processing device exceeds a predetermined distance.

9. The information processing device according to claim 1,
wherein the display control unit performs filtering of tag information to be displayed depending on contents of the tag information.

10. The information processing device according to claim 2, further comprising:
a target management unit configured to manage the position information of the real object and the tag information in association with each other.

11. The information processing device according to claim 10, further comprising:
an input control unit configured to set contents of the tag information.

12. The information processing device according to claim 11,
wherein the target management unit associates the tag information set by the input control unit with the real object.

13. The information processing device according to claim 11,
wherein the input control unit sets contents estimated from user-related information collected by the sensor unit as the contents of the tag information, and
the information collected by the sensor unit includes user's line of sight, user's gesture, and user's emotion.

14. The information processing device according to claim 12,
wherein the target management unit associates tag contents set by the input control unit with the real object specified from information collected by the sensor unit, and
the information collected by the sensor unit includes user's line of sight, user's gesture, voice information, and image information of the real object.

15. The information processing device according to claim 12,
wherein the target management unit associates tag contents set by the input control unit with the real object specified using SLAM techniques from information collected by the sensor unit.

16. The information processing device according to claim 12,
wherein the target management unit associates tag contents set by the input control unit with the real object specified from information regarding the real object that is collected using short-range wireless communication.

17. The information processing device according to claim 1,
wherein the information processing device is a head-mounted display.

18. An information processing method comprising:
controlling, by a processor, display of tag information managed in association with position information of a real object; and
controlling the display of the tag information in such a manner that the display of the tag information is changed depending on a change in the position information of the real object.

19. A program causing a computer to function as an information processing device comprising:
a display control unit configured to control display of tag information managed in association with position information of a real object,
wherein the display control unit controls the display of the tag information in such a manner that the display of the tag information is changed depending on a change in the position information of the real object.

20. A server comprising:
an object management unit configured to manage an update of position information of a real object on a basis of the collected position information of the real object; and
a control unit configured to cause the position information of the real object and tag information managed in association with the position information of the real object to be transmitted to an information processing device.
